(19) United States
(12) Patent Application Publication
(10) Pub. No.: US 2003/0018455 A1
(43) Pub. Date: Jan. 23, 2003

(54) Method for analytical jacobian computation in molecular modeling

(75) Inventor: Dan E. Rosenthal, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Protein Mechanics, Inc., Mountain View, CA

(21) Appl. No.: 10/053,348

(22) Filed: Nov. 2, 2001

Related U.S. Application Data
(60) Provisional application No. 60/245,730, filed on Nov. 2, 2000.
(60) Provisional application No. 60/245,688, filed on Nov. 2, 2000.
(60) Provisional application No. 60/245,731, filed on Nov. 2, 2000.
(60) Provisional application No. 60/245,734, filed on Nov. 2, 2000.

(51) Int. Cl. G06F 17/10

(52) U.S. Cl. 703/2

(57) ABSTRACT

A method for obtaining analytic Jacobians used in implicit integration methods in the computations for the dynamics of a physical system. With this method, the Jacobian with at least twice the number of digits of accuracy as a numerical Jacobian can be computed. This also results in the implicit integration method being more efficient because a smaller number of iterations are required to solve the nonlinear stage equations of the equations of motion, as well as the ability to take larger timesteps. This speedup in computation is very useful in molecular modeling.

### CROSS-REFERENCES TO RELATED APPLICATIONS

This application is entitled to the benefit of the priority filing dates of Provisional Patent Application No. 60/245,730, filed Nov. 2, 2000 ; and in addition, No. 60/245,688, filed Nov. 2, 2000 ; No. 60/245,731, filed Nov. 2, 2000 ; and No. 60/245,734, filed Nov. 2, 2000 ; all of which are hereby incorporated by reference.

### BACKGROUND OF THE INVENTION

The present invention is related to the field of molecular modeling and, more particularly, to computer-implemented methods for the dynamic modeling and static analysis of large molecules.

The field of molecular modeling has successfully simulated the motion (molecular dynamics or (MD)) and determined energy minima or rest states (static analysis) of many complex molecular systems by computers. Typical molecular modeling applications have included enzyme-ligand docking, molecular diffusion, reaction pathways, phase transitions, and protein folding studies. Researchers in the biological sciences and the pharmaceutical, polymer, and chemical industries are beginning to use these techniques to understand the nature of chemical processes in complex molecules and to design new drugs and materials accordingly. Naturally, the acceptance of these tools is based on several factors, including the accuracy of the results in representing reality, the size and complexity of the molecular systems that can be modeled, and the speed by which the solutions are obtained. Accuracy of many computations has been compared to experiment and generally found to be adequate within specified bounds. However, the use of these tools in the prior art has required enormous computing power to model molecules or molecular systems of even modest size to obtain molecular time histories of sufficient length to be useful.

There are two sources of computational complexity for molecular modeling tasks involving time integration:

1. The particular molecular model which is used to describe the locations, velocities and mass properties of the constituent atoms, the inter-atomic forces between them, and the interactions between the atoms and their surrounding environment; and

2. The particular numerical method used to advance the model through time. Time is advanced repeatedly by very short intervals, called timesteps, until a final time has been reached.

Substantial work has been completed in reducing the computational load for molecular models, such as the reduction of model complexity by constraining higher order modes with rigid body assumptions, simplifying the model with rigid or flexible substructuring, Order(N) dynamics, efficient implicit solvent models, and multipole methods for the force field models (see, for example, U.S. Pat. No. 5,424,963 on the commercial MBO(N)D software package). Co-pending applications, U.S. Appln. No.______ , entitled “METHOD FOR LARGE TIMESTEPS IN MOLECULAR MODELING,” and U.S. Appln. No.______ , entitled “METHOD FOR RESIDUAL FORM IN MOLECULAR MODELING,” both of which are filed of even date, claim priority from the previously cited provisional patent applications and which are assigned to the present assignee, and which are incorporated by reference herein, describe further improvements in molecular models and numerical methods.

The primary reason molecular simulations are so slow is that current numerical methods require very small timesteps, typically between 1 and 10 femtoseconds (10⁻¹⁵ to 10⁻¹⁴ seconds). Each timestep taken requires the computation of a new state (position and motion for each atom) of the particular molecular model, and then computation of the new set of forces resulting from the new state. For example, molecular dynamics simulations of the complex behavior of large molecules, such as the folding of a protein, typically need to cover a time span from at least a microsecond up to several seconds or even minutes. With techniques currently in common use, this results in the requirement to take 10⁹ to 10¹⁶ timesteps in the computer simulation. The per-step computations of the state, and especially the forces, grow very expensive as the problem size increases. Even with the fastest computers available today, months, years or even centuries of computer time are required to solve such problems even for systems of modest size.

Heretofore, it has been widely believed by molecular dynamicists that these small timesteps are an inevitable requirement of the need to maintain accuracy in the presence of the very high frequencies to be found in vibrations of molecular bonds. For example, see Leach, Molecular Modelling Principles and Applications, 1996, p. 328; Berendsen, in Computational Molecular Dynamics: Challenges, Methods, Ideas Deuflhard et al. (ed.), Springer, 1999, pg. 18; Rapaport, The Art of Molecular Dynamics Simulation, Cambridge, 1995, reprinted with corrections 1998, p. 57; and U.S. Pat. No. 5,424,963.

This common-sense belief is incorrect, however. The computer science sub-discipline of numerical analysis has produced an extensive theory of numerical integration for problems in which high frequencies exist but are of little interest. These problems are termed “stiff” problems (see, for example, Hairer and Wanner, Solving Ordinary Differential Equations II: Stiff and Differential-Algebraic Problems, 2^{nd} ed., Springer, 1996). In these cases, it is the stability of the integration method, not the required solution accuracy, which limits the timestep. Integration methods exist which have unconditional stability, meaning that in theory they can take arbitrarily large timesteps. Such methods have a mathematical property called “L-stability.” Only so-called “implicit” integration methods can be L-stable, but very few implicit integration methods actually are L-stable. Previously cited co-pending U.S. Patent Appln. No._______, entitled “METHOD FOR LARGE TIMESTEPS IN MOLECULAR MODELING,” covers the use of implicit and in particular L-stable integration methods.

The present invention covers another critical aspect of allowing the implicit and in particular L-stable integrators to take large timesteps, namely, more accurate methods for computing required components of the implicit integration methods called “Jacobians”.

But the same problem of high frequency molecular vibration for MD simulations causes problems for the calculation of Jacobians. For example, the repulsive van der Waal's forces that are generated as the electron orbitals of two atoms begin to overlap must be accounted for in a molecule. This quantum mechanical effect is often approximated by the so-called Lennard-Jones potential (Rapaport, op. cit.), which models the repulsive force as being proportional to 1/r¹³, where r is the distance between the centers of the atoms. This is an extreme stiff interatomic force which is characteristic of molecular dynamics (MD) simulations and poses particular difficulty for any numerical integration scheme used to advance time during the simulation. As a result and as mentioned previously, most prior art MD integration schemes have timesteps limited by the high frequencies generated by these extremely stiff repulsive forces. And in particular, the stiffness of the atomic forces greatly magnify the difficulty of forming certain required Jacobian matrices. Such Jacobian matrices are a necessary ingredient of any stable implicit integration scheme, such as described in the immediately cited co-pending application.

All general-purpose simulation codes provide routines to compute Jacobians numerically as follows. For a given equation to integrate \dot{y}=ƒ(y,t), the desired Jacobian is J=δƒ/δy and is numerically computed:

where

$$J = \frac{Δ f}{Δ y}$$

$$where$$

$$Δ f = f {\vert {}_{y = {y}_{2}} - f \vert}_{y = {y}_{1}}$$

$$Δ y = {y}_{2} - {y}_{1}$$

Note that the perturbation Δy has to be selected to give a good result and may be difficult to choose, especially for stiff systems. In contrast, analytic Jacobians are computed by solving directly, or in this case algorithmically, for the equation of the desired derivatives.

Linearized models are regularly produced analytically for simple systems. Such linearization is usually performed around an equilibrium solution. It is common in such packages as ACSL (Advanced Continuous Simulation Language), (ACSL Reference Guide, Mitchell Gauthier and Associates, 1996), and SPICE (a circuit simulation package), (R. Kielkowski, Inside SPICE, McGraw-Hill, 1998) to perform equilibrium analysis followed by linearization. Such linearization is performed numerically.

In contrast, the Jacobian of the present invention represents linearization about an instantaneous solution of the differential equations (non-equilibrium) and is generated analytically. It should be noted that another prior art approach to generating analytic Jacobians is to use automated differentiation tools such as ADIFOR (Automatic Differentiation of Fortran) (C. Bischof, et. al., ADIFOR 2.0 Users' Guide, Argonne National Laboratory, 1998) that can symbolically differentiate arbitrary equations. These tools could be used to implement this invention in practice. However, the structure of the equations must be exploited properly to minimize the computations, to avoid errors due to round off and term cancellations, and to avoid “equation swell” which could limit the size of problems solved.

Rather, the present invention allows for the calculation of analytic Jacobians for the effective implicit integration, including L-stable integrators, of the equations of motion of molecular models.

### SUMMARY OF THE INVENTION

The present invention provides for a method of modeling the behavior of a molecule. The method has the steps of selecting a torsion angle, rigid multibody model for said molecule, the model having equations of motion; selecting an implicit integrator; and generating an analytic Jacobian for the implicit integrator to integrate the equations of motion so as to obtain calculations of the behavior of the molecule. The analytic Jacobian J is derived from an analytic Jacobian of the Residual Form of the equations of motion and is described as:

$$\begin{matrix}J = ( \begin{matrix}\frac{\partial \dot{q}}{\partial q} & \frac{\partial \dot{q}}{\partial u} \\ \frac{\partial \dot{u}}{\partial q} & \frac{\partial \dot{u}}{\partial u}\end{matrix} ) {△}_{⩵} ( \begin{matrix}{J}_{qq} & {J}_{qu} \\ {J}_{uq} & {J}_{uu}\end{matrix} ) ; and \\ {J}_{qq} = \frac{\partial \dot{q}}{\partial q} = \frac{\partial ( Wu )}{\partial q} and {J}_{qu} = \frac{\partial \dot{q}}{\partial u} = W \\ {J}_{uq} = \frac{\partial \dot{u}}{\partial q} = - {M}^{- 1} \frac{\partial {ρ}_{u} ( q , u , z )}{\partial q} and \\ {J}_{uu} = \frac{\partial \dot{u}}{\partial u} = - {M}^{- 1} \frac{\partial {ρ}_{u} ( q , u , z )}{\partial u}\end{matrix}$$

where q are the generalized coordinates, u are the generalized speeds, W is a joint map matrix and M is the mass matrix and ρᵤ is the dynamic residual of the equations of motion, and z is −M⁻¹ρᵤ(q,u,0). The method can also be used for any physical system which can be modeled by a torsion angle, rigid multibody system.

The present invention also provides for the computer code for simulating the behavior of a molecule, or any physical system, which can be modeled by a torsion angle, rigid multibody system. A module in the computer code with an implicit integrator includes the analytic Jacobian as described above.

### BRIEF DESCRIPTION OF THE DRAWINGS

FIG. 1 is a representational block module diagram of the software system architecture in accordance with the present invention;

FIG. 2 illustrates the tree structure of the multibody system of the molecular model according to the present invention;

FIG. 3 illustrates the reference configuration of the FIG. 2 multibody system;

FIG. 4A illustrate a sliding joint between two bodies of the FIG. 2 multibody system; FIG. 4B illustrate a pin joint between two bodies of the FIG. 2 multibody system; FIG. 4C illustrate a ball joint between two bodies of the FIG. 2 multibody system;

FIG. 5 summarizes general computational steps for the Residual Form method and Direct Form methods used for the analytic Jacobian computation;

FIG. 6 is a chart which summarizes the general computational steps for the analytic Jacobian;

FIG. 7 is a plot of digits of accuracy versus perturbation to show the accuracy of analytic Jacobian over the numerical Jacobian.

### DESCRIPTION OF THE SPECIFIC EMBODIMENTS

General Description of the Present Invention

The numerical method used to advance time in the simulation of a modeled molecular system is called the integrator, or integration method. The integration proceeds by discretizing the governing equations of motion of the molecular system. In the case of an implicit integrator, this step results in a set of coupled nonlinear algebraic equations (the “stage” equations) and the solution of these equations yields the state vector for the molecular system at the next time step.

The present invention aids the solution of the stage equations. Because the atomic forces vary so rapidly over short distances, it is difficult to propagate atomic trajectories accurately. Small errors in the atomic positions lead to gross errors in the satisfaction of the stage equations. Since the Jacobian is used solve the stage equations iteratively, an inaccurate Jacobian leads to trial solution that are far from the correct solution. This leads to retraction of trial solutions and hinders the simulation.

Numerical Jacobians may be correct in only half their significant digits. An analytical Jacobian will often be correct in all but the last digit. The benefit of this result is that the integrator can take far fewer time steps to simulate the specified interval, allowing full exploitation of the theoretical stability of the integration method.

The ease or difficulty in producing the Jacobian depends crucially upon the formulation used to produce the governing equations. For instance, global Cartesian formulations produce equations with very limited explicit coordinate dependence. Producing an analytic Jacobian for such a formulation is well known. On the other hand, using internal coordinates (in which each molecular subunit's location is expressed relative to an earlier subunit's location) as independent variables has great benefits. This method is most valuable for any molecule modeled with any choice of internal coordinates, and in particular when used with protein models or other polymeric molecules using “torsion angles” between the residues as internal coordinates. An algorithm for producing an analytic Jacobian for a system formulated in torsion angles is extremely difficult to devise. However, the present invention achieves this task.

The present invention addresses a seemingly intractable problem: production of the analytic Jacobian for a formulation using internal coordinates, and specifically torsion angles, which is generally thought to be impractical. In addition to being more accurate than numerical Jacobians, the analytic Jacobians are also cheaper (in computing power) to produce. The present invention also recognizes a key result that the Jacobian of the state derivatives can be computed by applying a matrix inverse to the Jacobian of the computed torque method. This result allows significant savings in computer time and effort to construct the algorithm.

Furthermore, this method of producing analytic Jacobians for multibody system formulations using torsion angle, internal coordinates has not been seen in the general MBS literature. The present invention can be used for any torsion angle MBS formulation, which can be applied to many other disciplines besides molecular simulations, including, but not necessarily limited to, mechanical systems, robotic systems, vehicle systems, or any other system which could be described as a set of hinge-connected rigid bodies.

Overview of Description

The preferred embodiment is divided into several sections. The first set of sections describes the MD simulation architecture, the multibody system (MBS) definitions, and Residual Form of the MBS equations for the subsequent descriptions. The next set of sections discusses the definition of the Jacobian, its role in the implicit integration method, and the computation of the analytic Jacobian using the Residual Form. Also shown is the superior accuracy and performance of the analytic Jacobian vs. the numerical Jacobian. Further efficiencies in the computation of the analytic Jacobian are discussed, specifically, exploiting the rigid body MBS to “contract” the size of the Jacobian matrix, and exploiting the topological structure of the MBS to eliminate unnecessary computations.

To solve ordinary differential equations (ODEs), most of the prior art have used equations expressed in the Direct Form, i.e., \dot{y}=ƒ(y,t) (where \dot{y} means

$$( where \dot{y} means \frac{ⅆ y}{ⅆ t} ) .$$

The equations of motion for a biomolecular system can be cast into this form (and called the Direct Form). In molecular modeling, all prior art known to the present inventors have used the Direct Form. That is, \dot{q}=Wu, \dot{u}=M⁻¹ƒ, where q and u are generalized coordinates and speeds respectively, so that conventional ODE solution methods can be applied. However, this requires a matrix inversion of M (representing the mass of the system) at a cost of Order(N) to Order(N³) floating point operations (depending on algorithm used, where N is the number of degrees of freedom in the system), since the natural form of the equations gives rise to inertial coupling between the derivatives of the generalized speeds. That is, the equations are most naturally produced in the form \dot{q}−Wu=0, M\dot{u}−ƒ=0, where M, the mass matrix, depends explicitly upon the generalized coordinates q, i.e., M=M(q). This fact requires forming and effectively factoring the mass matrix each time the state derivatives are needed by the integrator in integrating the equations of motion over time. The generalized joint map matrix W is block diagonal and, although it is also dependent on the coordinates W=W (q), it does not have a significant computational cost.

In accordance with the present invention, a method for the solution of the equations of a molecular system is expressed in Residual Form to bypass the customary step of producing the state derivatives directly. The Residual Form method has the following steps:

1) Discretization of the solution variables. The specific form of discretization is dictated by the particular implicit integration method used to advance the molecular model in time. Implicit integration follows from the Residual Form. Implicit integration, especially L-stable integrators and other highly stable integrators, such as implicit Euler, Radau5, SDIRK3, SDIRK4, other implicit Runge-Kutta methods, and DASSL or other implicit multistep methods, also provide other advantages for molecular modeling. See, for example, the above-cited U.S. Patent Appln. No. ______, entitled “METHOD FOR LARGE TIMESTEPS IN MOLECULAR MODELING,” filed of even date. As a particularly simple example, when used with implicit Euler integration, the discretization is as follows:

\dot{q}=(qₙ−qₙ₋₁)/h, \dot{u}=(uₙ−uₙ₋₁)/h

where h is the timestep.

2) Substitution into the residual equations:

$$( \begin{matrix}{ρ}_{q} \\ {ρ}_{u}\end{matrix} ) = ( \begin{matrix}\dot{q} - W ( q ) u \\ M ( q ) \dot{u} - f ( t , q , u )\end{matrix} )$$

3) Solution of the resulting nonlinear algebraic equations

$$( \begin{matrix}{ρ}_{q} \\ {ρ}_{u}\end{matrix} ) = 0$$

for qₙ and uₙ.

The kinematic residual ρ_{q} compares an estimated \dot{q} generated from the implicit integrator to the derivatives computed by the routines for determining the joints of the molecular model, which is described in greater detail below. The second row of the residual is ρᵤ, the dynamic residual, which determines the degree to which an estimated \dot{u} satisfies the equations of motion.

The system mass matrix M and the so-called ‘bias-free hinge torque’ ƒ are both state dependent. The bias-free hinge torque is generated by the dynamic residual routine when the calculated \dot{u} vector passed to the residual routine is zero. In general, the hinge accelerations are a response to applied forces, joint torques, and motion-induced effects (such as Coriolis and centrifugal forces.) If the system were at rest, and subjected only to joint torques, it would be considered in a bias-free state. The real system with its actual inputs can be reduced to a bias-free state by computing mathematically. At the core of the module 54 is a multibody system submodule 66. The analysis module 56, which communicates with the physical model module 54 and the visualization module 58, provides solutions to the computational models of the molecular systems defined by the physical model module 54. The analysis module 56 consists of a set of integrator submodules 68 which integrate the differential equations of the physical model module 54. The integrator submodules 68 advance the molecular system through time and also provide for static analyses used in determining the minimum energy configuration of the molecular system. The analysis module 56 and its integrator submodules 68 contain most of the subject matter of the present invention and are described in detail below.

The visualization module 58 receives input information from the biochem components module 52 and the analysis module 56 to provide the user with a three-dimensional graphical representation of the molecular system and the solutions obtained for the molecular system. Many visualization modules are presently available, an example being VMD (A. Dalke, et al., VMD User's Guide, Version 1.5, June 2000, Theoretical Biophysics Group, University of Illinois, Urbana, Ill.).

The described software code is run on conventional personal computers, such as PCs with Pentium III or Pentium IV microprocessors manufactured by Intel Corporation of Santa Clara, Calif. This contrasts with many current efforts in molecular modeling which use supercomputers to perform calculations. Of course, further speed improvements can be obtained by running the described software on faster computers.

Molecular Model and Multibody System Description

The integrators described below in the submodule 68 operate upon a set of equations which describe the motion of the molecular model in terms of a multibody system (MBS). To aid the computation of the integration methods described in detail below, a torsion angle, rigid body model is used to describe the subject molecule system, in accordance with the present invention. Internal coordinates (selected generalized coordinates and speeds) are used to describe the states of the molecule.

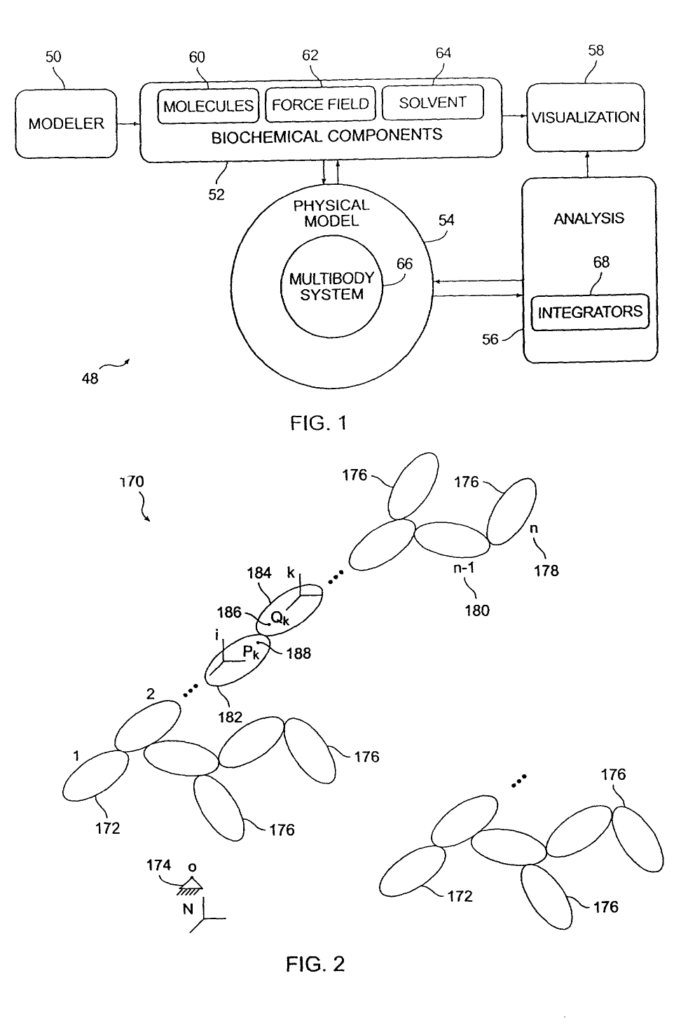

The MBS is an abstraction of the atoms and effectively rigid bonds that make up the molecular system being modeled and is selected to simplify the actual physical system, the molecule in its environment, without losing the features important to the problem being addressed by the simulation. With respect to the general system architecture illustrated in FIG. 1, the MBS does not include the electrostatic charge or other energetic interactions between atoms nor the model of the solvent in which the molecules are immersed. The force fields are modeled in the submodule 62 and the solvent in the submodule 64 in the biochem components module 52.

FIG. 2 illustrates the tree structure of the MBS of a subject molecule. The basic abstraction of the MBS is that of one or more collections of hinge-connected rigid bodies 170. A rigid body is a mathematical abstraction of a physical body in which all the particles making up the body have fixed positions relative to each other. No flexing or other relative motion is allowed. A hinge connection is a mathematical abstraction that defines the allowable relative motion between two rigid bodies. Examples of these rigid bodies and hinge connections are described below.

One or more of the bodies, called base bodies 172, have special status in that their kinematics are referenced directly to a reference point on ground 174. The system graph is one or more “trees”. An important property of a tree is that the path from any body to any other body is unique, i.e., the graph contains no loops. The bodies in the tree are n in number (the base has the label 1). The bodies in the tree are assigned a regular labeling, which means that the body labels never decrease on any path from the base body to any leaf body 176. A leaf body is one that is connected to only a single other body. A regular labeling can be achieved by assigning the label n to one of the leaf bodies 178 (there must be at least one). If this body is removed from the graph, the tree now has n−1 bodies. The label n−1 is then assigned to one of its leaf bodies 180, and the process is repeated until all the bodies have been labeled. This is also done for any remaining trees in the system.

To help maintain the relationship between the bodies, an integer function is used to record the inboard body for each body of the system. The inboard body for each base is ground and i, the parent or inboard body 182 for body k 184, is referred to as i=inb(k). Additionally, the symbol N refers to the inertial, or ground frame 174. A superscript O refers to the ground origin (0,0,0).

The symbol for the vector from one point to another contains the name of the two points. Thus, r^{PQ} is the vector from the point P to point Q. A vector representing the velocity of a point in a reference frame contains the name of the point and the reference frame: ^{N}ν^{P}. Certain symbols to be introduced later relate two reference frames. In this case, the symbol contains the name of two frames. Thus, ⁱC^{k} is the direction cosine matrix for the orientation of frame k in frame i. This symbol refers to the direction cosine matrix for a typical body in its parent frame. Thus, ⁱC^{k}(j) indicates the actual body j in question. The left and right superscripts do not change with the body index. This is also true for the other symbols. An asterisk indicates the transpose: H*(k), for example. A tilde over a vector indicates a 3 by 3 skew-symmetric cross product matrix: \tilde{ν}w [symbol] νv×w. Eᵢ is an i by i identity matrix, and 0ᵢ is a zero vector of length i and 0ᵢ is an i by i zero matrix.

Rigid Bodies of the Model

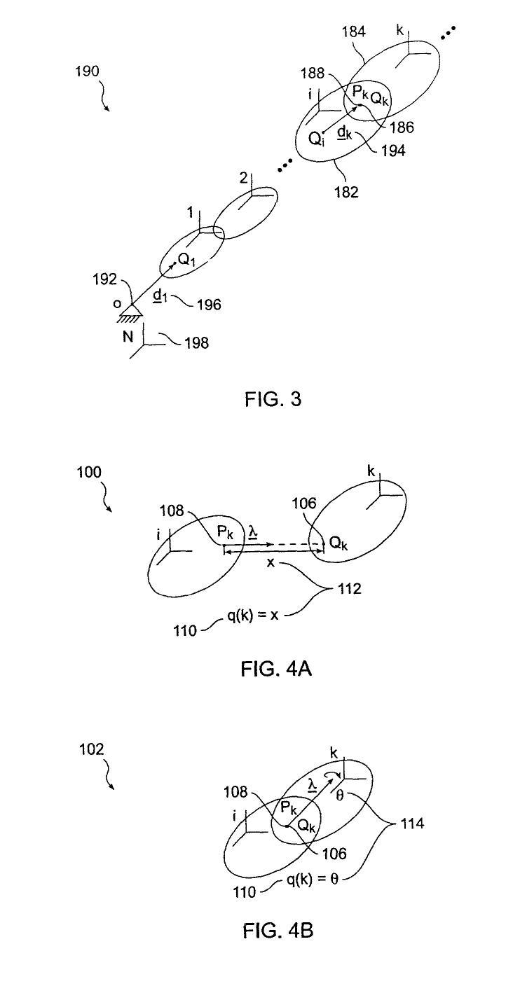

FIG. 3 illustrates the reference configuration 190 of a sample “tree” of the MBS. More than one tree is allowed. A point of each body is designated as Q, its hinge point. For example point Qₖ 186 is the hinge point for body k 184. A fixed set of coordinate axes is established in the inertial frame 198. An arbitrary configuration of the MBS is chosen as its reference configuration 190. While in this configuration the image of the inertial coordinate axes is used to establish a set of body-fixed axes in each body. In the reference configuration each hinge point Q is coincident with P, a point of its parent body (or extended body.) For each body, point P is called the body's inboard hinge point. So the inboard hinge point Pₖ 188 for body k 184 is a point fixed in its parent body i 182. The inboard hinge point for each base body is a point O 192 fixed in ground. The expanded view that shown in FIG. 2 more clearly shows that point Qₖ 186 is fixed in body k 184 and point Pₖ 188 is fixed in parent body i 182.

The hinge point locations define d(k) 194, a constant vector for each body, and can also be written r^{Q}^{ᵢ}^{P}^{ₖ}. The vector for body k is fixed in its parent body i. It spans from the hinge point for body i to the inboard hinge point for body k. The vector d(1) 196 spans from the inertial origin to the first base body's inboard hinge point (also a point fixed in ground), and can be written r^{OQ}^{₁}.

For a body, m(k), p(k), and I_{Q}_{ₖ}(k) define the mass properties of body k for its hinge point Qₖ. These are, respectively, the mass, the first mass moment, and the inertia matrix of the body for its hinge point in the coordinate frame of the body. For a rigid body made up of a distribution of particles, the mass properties are constants that are computed by a preprocessing module. The details of these computations can be found in standard references, such as Kane, T. R., Dynamics, 3^{rd} Ed., January 1978, Stanford University, Stanford, Calif.

Let M(k), the spatial inertia of body k for its hinge point Qₖ, be given by the symmetric 6 by 6 matrix

$$M ( k ) = [ \begin{matrix}{{I}_{=}}_{{Q}_{k}} ( k ) & \tilde{p} ( k ) \\ - \tilde{p} ( k ) & m ( k ) {{E}_{=}}_{3}\end{matrix} ]$$

Each joint in the system is described by geometric data. For instance, a pin joint is characterized by an axis fixed in the two bodies connected by the joint. The particular data for a joint depends on its type. The number n, the inb function, the system mass properties, the vectors d(k), and the joint geometric data (including joint type) constitute the system parameters.

Joints and Generalized Coordinates of the Model

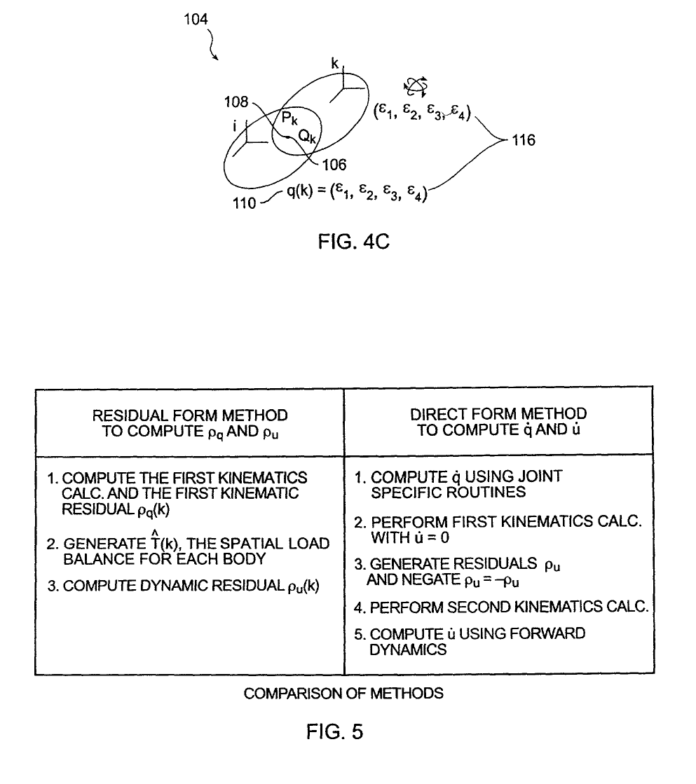

FIGS. 4A-4C illustrate the joint definitions of the preferred embodiment of the MBS: the slider joint 100, the pin joint 102, and the ball joint 104. Each joint allows translational or rotational displacement of the hinge point Qₖ 106 relative to the inboard hinge point Pₖ 108. These displacements are parameterized by q(k) 110, the generalized coordinates for body k. In passing, it should be noted that generalized coordinates are examples of generalized quantities, which refer to quantities that have both rotational character and translational character. For instance, a generalized force acting at a point consists of both a force vector and a torque vector. The generalized coordinate q(k) for the slider joint 100 is the sliding displacement x 112. The generalized coordinate q(k) for the pin joint 102 is the angular displacement θ 114. The generalized coordinate q(k) for the ball joint 104 is the Euler parameters (ε₁,ε₂,ε₃,ε₄) 116.

Each joint may be a pin, slider, or ball joint; or a combination of these joints. Many other joint types are possible, including, but not limited to, free joints, U-joints, cylindrical joints, and bearing joints. For instance, q(k)=(x, y, z), the inertial measure numbers of the vector from the base body inboard hinge point to the base body hinge point express the base body displacement in ground as three orthogonal slider joints. A free joint consists of three orthogonal slider joints combined with a ball joint, and has the full 6 degrees of freedom.

The collection of generalized coordinates for all the bodies comprises the vector q, the generalized coordinates for the system.

Given the generalized coordinates for a particular joint, two quantities: r^{P}^{ₖ}^{Q}^{ₖ}(k), the joint translation vector and ⁱC^{k}(k), the direction cosine matrix for body k in its parent are formed. The translation vector r^{P}^{ₖ}^{Q}^{ₖ}(k) expresses the vector from the inboard hinge point P of body k to the hinge point Q of body k, in the coordinate frame of the parent body. Details of these computations depend on the joint type and can be easily derived. For purposes of this description, access to a function that can generate r^{P}^{ₖ}^{Q}^{ₖ}(k) and ⁱC^{k}(k) given the system generalized coordinates is assumed.

As introduced, the choice of hinge point for each body is arbitrary. However, judicious choice greatly simplifies matters. For instance, for pin joints the hinge point should be chosen as a point on the axis of the joint. For this choice points P and Q remain coincident for all values of the joint angle, so the joint translation is zero. If the point Q is chosen at a distance from the axis, points P and Q move relative to each other:

r^{P}^{ₖ}^{Q}^{ₖ}(k)=λ×r^{OQ}^{ₖ} sin θ−(1−cos θ)(E₃−λλ*)r^{OQ}^{ₖ}

where λ is the joint axis unit vector, θ is the joint angle, and r^{OQ}^{ₖ} is the vector from any point on the axis to point Q.

For pin joints and ball joints, a point on the axis is always chosen as the hinge point. For these joints the translation vector r^{P}^{ₖ}^{Q}^{ₖ}(k) is zero.

For a slider joint, the translation vector r^{P}^{ₖ}^{Q}^{ₖ}(k) is q(k)λ.

The direction cosine matrix for a pin is

ⁱC^{k}(k)=E₃cosθ+\tilde{λ}sinθ+λλ^{*}(1−cos θ)

The direction cosine matrix for a slider is E₃.

Generalized Speeds of the Model

Let ⁱV^{k}(k), the generalized velocity of the hinge point of body k measured in its parent i, be parameterized by u(k), a set of generalized speeds. Then:

$${}_{}^{i}{V}{}_{}^{k} ( k ) = ( \begin{matrix}{}_{}^{i}{ω}{}_{}^{k} ( k ) \\ {}_{}^{i}{v}{}_{}^{{Q}_{k}} ( k )\end{matrix} ) = {H}^{*} ( k ) u ( k )$$

Here, the matrix H(k) is called the joint map for this joint. It is a nᵤ(k) by 6 matrix, where nᵤ(k) is the number of degrees of freedom for the joint (1 for a pin or slider, 3 for a ball, 6 for a free joint). H(k) can, in general have dependence on coordinates q. Given the generalized speeds for the joint, the joint map generates the joint linear and angular velocity, expressed in the child body frame. The following are used for the joints:

$$H ( k ) = [ \begin{matrix}\underline{λ} & 0 & 0 & 0\end{matrix} ] , pin$$

$$H ( k ) = [ \begin{matrix}0 & 0 & 0 & \underline{λ}\end{matrix} ] , slider$$

$$H ( k ) = [ \begin{matrix}{\underline{\underline{E}}}_{3} & {\underline{\underline{0}}}_{3}\end{matrix} ] , ball$$

$$H ( k ) = [ \begin{matrix}{\underline{\underline{E}}}_{3} & {\underline{\underline{0}}}_{3} \\ {\underline{\underline{0}}}_{3} & {}_{}^{i}{C}{}_{}^{k} ( k )\end{matrix} ] , free$$

The collection of generalized speeds for all the bodies comprises the vector u, the generalized coordinates for the system. As before, access to a function that can generate the vector ⁱV^{k}(k) given (q,u) and a specific joint type, is assumed. Access to a function that can compute the derivatives \dot{q}(k)=\dot{q}(q(k),u(k)) is also assumed. This routine generates the time derivative of the generalized position coordinates:

\dot{q}=W(q)u

where W(q) is a block diagonal matrix that relates \dot{q} and u, with each block depending upon the joint type:

\dot{q}=u for pin joint, slider joint

$$[ \begin{matrix}{\dot{ϵ}}_{1} \\ {\dot{ϵ}}_{2} \\ {\dot{ϵ}}_{3} \\ {\dot{ϵ}}_{4}\end{matrix} ] = \frac{1}{2} [ \begin{matrix}{ϵ}_{4 } & - {ϵ}_{3} & {ϵ}_{2 } \\ {ϵ}_{3} & {ϵ}_{4} & - {ϵ}_{1 } \\ - {ϵ}_{2} & {ϵ}_{1} & {ϵ}_{4} \\ - {ϵ}_{1 } & - {ϵ}_{2 } & {ϵ}_{4}\end{matrix} ] [ \begin{matrix}{ω}_{1} \\ {ω}_{2} \\ {ω}_{3}\end{matrix} ] for ball joint$$

where q=[ε₁ ε₂ ε₃ ε₄]* and u=[ω₁ ω₂ ω₃]*

and a free joint is a combination of 3 slider joints and one ball joint. Note that there are 4 \dot{q}'s (derivatives of the Euler parameters) associated with 3 u 's for ball joints.

Similarly, ⁱA^{k}(k), the generalized acceleration of the hinge point of body k in its parent, is given by:

$${}_{}^{1}{A}{}_{}^{k} ( k ) = ( \begin{matrix}{}_{}^{i}{α}{}_{}^{k} ( k ) \\ {}_{}^{i}{α}{}_{}^{{Q}_{k}} ( k )\end{matrix} ) = {H}^{*} ( k ) \dot{u} ( k )$$

It is these generalized coordinates q, and generalized speeds u, the internal coordinates for purposes of this description, of the molecular system which are calculated. Rather than working with the typical inertial coordinates (x, y, z) and speeds in these inertial coordinate systems, calculations for the subject molecular system are reduced.

Calculations of the Equations of Motion

With the exemplary rigid multibody, torsion angle model described, the equations of motion can now be calculated. In accordance with the present invention, the motion of the MBS molecular model is determined by the Residual Form. The Residual Form method requires calculations termed the “first” kinematic calculations to distinguish them from the “second” kinematic calculations, which are further required by the Direct Form (which is included in this description for purposes of comparison).

First Kinematic Calculations for the Molecular Model

In the first kinematic calculations, given the internal coordinates of the molecular system, (q, u, \dot{u}) and the system parameters, the following position, velocity and acceleration kinematics are computed for each rigid body k of the molecular model. (In passing, it should be noted that when the First Kinematic calculations are done for the Residual Form method, the \dot{u} is passed in as a guess of the solution which the integration method then refines to the correct solution. In contrast, \dot{u} is set to zero when used for the Direct Form method. This is shown clearly in the later descriptions of the two methods.)

For each body k compute:

^{N}C^{k}(k), r^{Q}^{ᵢ}^{Q}^{ₖ}(k), r^{OQ}^{ₖ}(k), ⁱφ^{k}(k),

^{N}ω^{k}(k), ^{N}ν^{Q}^{ₖ}(k)V(k),

^{N}α^{k}(k), ^{N}α^{Q}^{ₖ}(k), A(k)

These computations are done recursively, starting from each base body and progressing to the leaves.

^{N}C^{k}(k), the direction cosine matrix for body k in ground is defined as:

^{N}C^{k}(1)=ⁱC^{k}(1)

^{N}C^{k}(k)=^{N}C^{k}(i)ⁱC^{k}(k), k=2, . . . n, i=inb(k)

ⁱC^{k}(k) comes from the joint routine described above.

r^{Q}^{ᵢ}^{Q}^{ₖ}(k), the position vector from Qᵢ, the hinge point of the parent of body k to Qₖ, the hinge point of body k, expressed in the parent frame, is defined as:

r^{Q}^{ᵢ}^{Q}^{ₖ}(k)=d(k)+r^{P}^{ₖ}^{Q}^{ₖ}(k), k=1, . . . n

r^{P}^{ₖ}^{Q}^{ₖ}(k) comes from the joint routine.

r^{OQ}^{ₖ}(k), the position vector from the inertial origin O to Qₖ, the hinge point of body k, expressed in the global frame, is defined

r^{OQ}^{ₖ}(1)=r^{Q}^{ᵢ}^{Q}^{ₖ}(1)

r^{OQ}^{ₖ}(k)=r^{OQ}^{ₖ}(i)+^{N}C^{k}(i)r^{Q}^{ᵢ}^{Q}^{ₖ}(k), k=2, . . . n, i=inb(k)

ⁱφ^{k}(k), the rigid body transformation operator for body k is defined

$${}_{}^{i}{φ}{}_{}^{k} ( k ) = ( \begin{matrix}{}_{}^{i}{C}{}_{}^{k} ( k ) & {{\tilde{r}}^{{Q}_{i} {Q}_{k}} ( k )}^{i} {C}^{k} ( k ) \\ {\underline{\underline{0}}}_{3} & {}^{i} {C}^{k} ( k )\end{matrix} ) , k = 1 , … n$$

V(k), the spatial velocity for body k at its hinge point, expressed in the frame of body k, is defined

$$V ( 1 ) {=}^{Δ} ( \begin{matrix}{}_{}^{N}{ω}{}_{}^{k} ( 1 ) \\ {}_{}^{N}{v}{}_{}^{{Q}_{k}} ( 1 )\end{matrix} ) = {}_{}^{i}{V}{}_{}^{k} ( 1 )$$

$$V ( k ) {=}^{Δ} ( \begin{matrix}{}_{}^{N}{ω}{}_{}^{k} ( k ) \\ {}_{}^{N}{v}{}_{}^{{Q}_{k}} ( k )\end{matrix} ) = {}_{}^{i}{φ}{}_{}^{{k}^{*}} ( k ) V ( i ) + {}_{}^{i}{V}{}_{}^{k} ( k ) , \\ k = 2 , … n , i = i n b ( k )$$

A(k), the spatial acceleration for body k at its hinge point, expressed in the frame of body k, is defined

$$A ( 1 ) {=}^{Δ} ( \begin{matrix}{}_{}^{N}{α}{}_{}^{k} ( 1 ) \\ {}_{}^{N}{α}{}_{}^{{Q}_{k}} ( 1 )\end{matrix} ) = {}_{}^{i}{A}{}_{}^{k} ( 1 )$$

$$A ( k ) {=}^{Δ} ( \begin{matrix}{}_{}^{N}{α}{}_{}^{k} ( k ) \\ {}_{}^{N}{α}{}_{}^{{Q}_{k}} ( k )\end{matrix} ) = \overline{A} + ( \begin{matrix}\tilde{ω} & {{0}_{3}}_{\underline{\_}} \\ {{0}_{3}}_{\underline{\_}} & 2 \tilde{ω}\end{matrix} ) {}_{}^{i}{V}{}_{}^{k} ( k ) + {}_{}^{i}{A}{}_{}^{k} ( k ) , \\ k = 2 , … n , i = i n b ( k )$$

where

$$\overline{A} = {}_{}^{i}{φ}{}_{}^{{k}^{*}} ( k ) A ( i ) + ( \begin{matrix}{{0}_{3}}_{\underline{\_}} \\ {}_{}^{i}{C}{}_{}^{{k}^{*}} ( k ) ( {}_{}^{N}{ω}{}_{}^{k} ( i ) \times {}_{}^{N}{ω}{}_{}^{k} ( i ) \times {r}^{{Q}_{l} {Q}_{k}} ( k ) )\end{matrix} )$$

$$ω = {}_{}^{i}{C}{}_{}^{{k}^{*}} ( k ) {}_{}^{N}{ω}{}_{}^{k} ( i )$$

Of course, the computations can all be computed in a single pass if desired.

After completing these steps for one incremental time step, the MBS can service kinematics requests to compute the (generalized) position, velocity, or acceleration information for any point of any body. This is done by computing the required information for any point in terms of the hinge quantities for its body, using standard rigid body formulas.

Residual Computation

With the first kinematic calculations described above, the residual computation for the Residual Form method can be determined. A detailed description of the Residual Form and its application to molecular modeling is found in the previously cited co-pending U.S. Patent Appln. No._______ , entitled, “METHOD FOR RESIDUAL FORM IN MOLECULAR MODELING,” filed of even date. This computation fills in two partitions of the vector

$$( \begin{matrix}{ρ}_{q} \\ {ρ}_{u}\end{matrix} )$$

given previously. The first partition is called ρ_{q}, the kinematic residual, and the second partition is called ρᵤ, the dynamic residual. The kinematic residual is computed from the difference between a \dot{q}, which is passed-in from the (implicit) integration submodules 66, and the derivative computed by each joint:

\dot{q}−W(q)u=ρ_{q}

The dynamics residual is also computed. Starting with a given state of the molecular model, i.e., given (q,u,\dot{u}) and the system parameters, a program routine models the ‘environment’ of the MBS. Such routines are readily available to, or can be created by, practitioners in the computer modeling field. The routine takes the values (q,u) determined by and passed in from the integration submodules 66 and returns (the state-dependent)

$$T ( k ) = ( \begin{matrix}{T}_{{Q}_{k}} ( k ) \\ F ( k )\end{matrix} ) ,$$

the applied spatial force for a body k at its hinge point Qₖ, and σ(k), the hinge torque for the body k. The dynamics residual, ρᵤ(k), associated with generalized speeds u(k) for the body k is then computed by the following steps:

1. Perform the calculations for the molecular model by the Residual Form as described above with the passed-in state values (q,u,\dot{u});

2. Generate \hat{T}(k), the spatial load balance for each body k in the model having n bodies:

$$\hat{T} ( k ) = M ( k ) A ( k ) + ( \begin{matrix}{}_{}^{N}{\tilde{ω}}{}_{}^{k} ( k ) ( {{I}_{\underline{\_}}}_{Q} ( k ) {}_{}^{N}{ω}{}_{}^{k} ( k ) ) \\ {}_{}^{N}{\tilde{ω}}{}_{}^{k} ( k ) ( {}_{}^{N}{ω}{}_{}^{k} ( k ) \times p ( k ) )\end{matrix} ) - T ( k )$$

k=1, . . . n

3. Compute ρᵤ(k)

for k=n to 2 by −1

ρᵤ(k)=H(k)\hat{T}(k)−ρ(k)

i=inb(k)

\hat{T}(i)+=ⁱφ^{k}(k)\hat{T}(k)

end

ρᵤ(1)=H(1)\hat{T}(1)

The Residual Form method evaluates the extent to which the system differential equations are satisfied. Zero residual indicates that the applied forces are in balance with the inertia forces. However, this does not mean the system is in static equilibrium, but rather that the applied forces would reproduce the given \dot{u} when applied to the system in the state (q,u). The residuals can be interpreted as that additional hinge torque needed to balance the applied and inertia forces. In the literature this method is known as either inverse dynamics, or the method of computed torques. It governs the case where the \dot{u} are all prescribed. At this point all the computations required for the Residual Form are complete. The residuals ρ_{q} and ρᵤ are used directly by the implicit integrator in the integrator submodule 68.

Second Kinematics Calculations for the Molecular Model

To carry out the Direct Form method, calculations in addition to the first kinematics calculations are required. These additional calculations are termed the second kinematics calculations. The values P(k),D(k),ⁱψ^{k}(k),ⁱK^{k}(k) are computed as follows:

1. Perform the calculations for the Molecular Model by the Residual Form as described above, i.e., the first kinematics calculations.

2. P(k), the articulated body inertia of each body k, is initialized.

P(k)=M(k), k=1, . . . ,n

3. The objects below are then generated:

for k=n to 2 by −1

D(k)=H(k)P(k)H*(k)

G=P(k)H*(k)D⁻¹(k)

\overline{τ}=E₆−GH(k)

ⁱψ^{k}(k)=ⁱφ^{k}(k)\overline{τ}

ⁱK^{k}(k)=ⁱφ^{k}(k)G

i=inb(k)

P(i)+=ⁱψ^{k}(k)P(k)ⁱψ^{k}*(k)

end

D(1)=H(1)P(1)H*(1)

The functional dependence of these quantities is only upon the generalized coordinate q. Therefore, the first kinematics calculations are programmed in anticipation of performing the second kinematics calculations.

Forward Dynamics Calculations

Finally, \dot{u} is calculated by sweeping inboard, then outboard, of the molecule:

z(k)=0₆, k=1, . . . n

for k=n to 2 by −1

ε(k)=ρᵤ(k)−H(k)z(k)

υ(k)=D⁻¹(k)ε(k)

i=inb(k)

z(i)+=ⁱψ^{k}(k)z(k)+ⁱK^{k}(k)ρᵤ(k)

end

ε(1)=ρᵤ(1)−H(1)z(1)

υ(1)=D⁻¹(1)ε(1)

\dot{u}(1)=υ(1)

δ(1)=H*(1)υ(1)

for k=2 to n

i=inb(k)

δ(k)=ⁱψ^{k}*(k)δ(i)+H*(k)υ(k)

\dot{u}(k)=υ(k)−ⁱK^{k}*(k)δ(i)

end

With the First and Second Kinematics Calculations, and the Forward Dynamics Calculations, the Direct Form method is available.

Direct Form Method for the Equations of Motions

The Direct Form method takes the current state (q,u) and computes the derivatives (\dot{q},\dot{u}) using the above algorithms, which are then used by the integration method to advance time.

Given: (q,u)

Compute: (\dot{q},\dot{u})

1. Compute \dot{q} using joint specific routine as above

2. Perform above First Kinematics Calculations with \dot{u}=0

3. Generate residuals ρᵤ as above

4. Negate the residuals ρᵤ=−ρᵤ

5. Perform Second Kinematics Calculations

6. Compute \dot{u} using Forward Dynamics Calculations above

The Direct Form method produces the hinge accelerations \dot{u} in response to the applied forces acting on the system. FIG. 5 summarizes the computation steps of the Residual Form method and the Direct Form method.

Jacobians in Implicit Integration

The MD equations which model a molecule (such as a protein), are implemented as a multibody system (MBS). These equations represent Newton's Laws and are expressed as a set of differential equations \dot{y}=ƒ(y,t). The differential equations are implemented using a suite of Order(N) multibody dynamics methods. To advance the equations in time, in accordance with the present invention, an implicit method of numerical integration is used, in particular, L-stable implicit integration methods, such as implicit Euler, Radau5, and SDIRK3.

An important ingredient of this integration process is formation of the Jacobian of the differential equations. This is

$$J {=}^{Δ} \frac{\partial f}{\partial y}$$

Since the function ƒ is itself computed by an algorithm rather than by an explicit formula, the Jacobian computation represents a substantial amount of work. In the simplest approach, the Jacobian can be formed numerically by differencing the derivative routine. This is a delicate operation because the quality of the Jacobian is a tradeoff between round-off and truncation errors. Typically half the working precision in the result is retained by choosing a good perturbation size in the difference scheme. In practice, though, this is difficult to do.

However, the structure of the governing equations may be exploited to improve the Jacobian computation. The exemplary multibody dynamics methods illustrate this. The algorithms involved compute exact derivatives, even though numerical methods are used to execute the formulas. The derivatives obtained are in error by amounts that depend upon round off and the conditioning of the multibody system under consideration. But no approximations are involved at the equation level.

In general, G, the iteration matrix used in the Newton loop of the implicit integrator has the form G=E−αJ, where E is the identity matrix and α is be some scalar function of the timestep. See the previously referenced U.S. Patent Appln. No._______ , entitled “METHOD FOR LARGE TIMESTEPS IN MOLECULAR MODELING,” filed of even date, for a description of implicit integrators. Changes in step size require refactoring G , but not reforming J. Reforming J is needed only when the Jacobian is needed at a new state. G is used in a linear subproblem within a Newton loop. The following is solved:

GΔy=−r(yₙⁱ),

yₙⁱ⁺¹=yₙⁱ+Δy

where r(y) is the residual function for that particular implicit integration method.

As shown later, J has a special structure, which is inherited by G. This means that equation solving with G can be done at reduced cost, if the structure is exploited.

The quality of the Jacobian affects the ability to solve the nonlinear equations resulting from discretization in the integrator. Failure to solve the Newton loop may require retraction of a trail step and reduction of the integration time step. The timestep should be controlled by accuracy, rather than failures in the Newton loop.

Computation of Analytic Jacobian

The Jacobian J is a matrix which represents a linearization of the equations of motion. Normally, the governing equations for a dynamical system are linearized around an equilibrium state, or perhaps a state of steady motion. In this case, the equations are linearized around an arbitrary state so all possible contributing terms should be developed. It is customary to describe J in terms of its partitions:

$$J ( q , u ) = ( \begin{matrix}\frac{\partial \dot{q}}{\partial q} & \frac{\partial \dot{q}}{\partial u} \\ \frac{\partial \dot{u}}{\partial q} & \frac{\partial \dot{u}}{\partial u}\end{matrix} ) {=}^{Δ} ( \begin{matrix}{J}_{q q} & {J}_{q u} \\ {J}_{u q} & {J}_{u u}\end{matrix} )$$

Structure of J_{qq} AND J_{qu}

The \dot{q} equation is \dot{q}=Wu, where the matrix W has a block-diagonal structure. Each block depends upon the joint type. Pins and slider joints give rise to 1 by 1 identity blocks. A ball joint generates a 4 by 3 block that expresses the Euler parameter derivatives in terms of Euler parameters and body angular velocity measure numbers (generalized speeds).

From the \dot{q} equation above, these two partitions of the Jacobian matrix are formed:

$${J}_{q q} = \frac{\partial W ( q )}{\partial q} u$$

$${J}_{q u} = W$$

These equations are to be interpreted for symbolic purposes only. In practice, there is no need to generate the matrix W explicitly. The non-zero block diagonal elements are filled in as discussed in the previous section on the kinematic residual.

Structure of J_{uq} AND Jᵤᵤ

The \dot{u} derivatives are more complicated. Since \dot{u}=−M⁻¹ρᵤ,

$$\frac{\partial ( - {M}^{- 1} {ρ}_{u} )}{\partial q}$$

and

$$\frac{\partial ( - {M}^{- 1} {ρ}_{u} )}{\partial u}$$

must be computed. (Note that ρᵤ is the residual of the dynamics routine developed earlier). Here a key result from the field of Numerical Analysis is used to avoid the derivative of the matrix inverse.

Suppose A(x)y(x)=b(x), then we can write y(x)=A⁻¹(x)b(x). If y(x₀)=z is known, and the value of

$$\frac{\partial y ( x )}{\partial x} {\vert}_{x = x0}$$

must be obtained, we have

$$\frac{\partial y}{\partial x} {\vert}_{x = x0} = {A}^{- 1} ( x0 ) \frac{\partial }{\partial x} ( b ( x ) - A ( x ) z ) {\vert}_{x = x0}$$

where z=A⁻¹b is held fixed when forming the right-hand side of the equation. Applied to the described multibody routines,

$$\frac{\partial \dot{u}}{\partial x} = - \frac{\partial }{\partial x} ( {M}^{- 1} {ρ}_{u} ( q , u , 0 ) ) = - {M}^{- 1} \frac{\partial }{\partial x} {ρ}_{u} ( q , u , z )$$

where z [symbol] M⁻¹ρᵤ(q,u,0). This result avoids the computing of the derivative of M⁻¹, which is a hypermatrix. The matrix inverse is “pulled-out”. In the above equation, “x” is either the generalized coordinate q or the generalized speed u, depending on the Jacobian partition that is to be computed.

In summary, to compute the blocks J_{uq} and Jᵤᵤ, three steps are followed:

1. Given (q,u) compute z [symbol] −M⁻¹ρᵤ(q,u,0) using the Direct Form method. This simply says to compute \dot{u} from the current state and save it as the variable z.

2. Compute the analytic Jacobian of the dynamics residual routine. In this step, the matrix

$$\frac{\partial }{\partial x} {ρ}_{u} ( q , u , z )$$

is to be formed. This quantity clearly depends upon the vector z computed in Step 1. Note that the numerical value of the residual ρᵤ in this step is zero for each element since we are computing the Jacobian around a consistent solution of the motion equations. The partitions J_{uq} and Jᵤᵤ of the Residual Jacobian are obtained by substituting “q” and “u” for the “x” above.

3. Back-solve the result of Step 2 with the mass-matrix to obtain the desired block. The back-solve operation is accomplished in the Direct Method routine by processing a residual vector into a \dot{u} vector. The Second Kinematics Step only needs to be performed once, since the back-solves are done at the nominal value of the state. In fact, the Second Kinematics routine must have been called in Step 1 while computing z, so the variables should still be cached.

In words, the Jacobian of our derivative routine can be formed by back-solving the Jacobian of our residual routine. The residual Jacobian is much simpler to compute than the derivative Jacobian. Steps 2 and 3 above are derived in the following sections.

The Residual Jacobian

The computation of the Residual Jacobian is closely related to the Residual Form method for dynamics, which is summarized here:

1. Perform an outboard pass that computes the kinematic data that depends upon position and velocity.

2. Make a call to the force routine which generates the atomic forces and consolidates them into spatial loads acting on the bodies.

3. Perform another kinematic pass that computes acceleration level quantities (using passed-in \dot{u}), and combines inertia forces with the spatial loads from Step 2.

4. Perform an inward pass that generates the residual at each joint. This pass recursively computes the resultant of the (spatial) inertial and applied forces for the ‘nest’ of bodies outboard of the joint in question. The residual is the projection of the resultant on the joint's degrees of freedom, given by the joint map data.

At a high level the residual computation can be considered to depend upon two kinds of forces: ‘motion forces’ and external forces. The motion forces are computed directly by the multibody system. The external forces are available to the multibody system from a force modeling routine that computes the various interatomic forces such as electrostatics and solvents. A similar procedure is followed when computing the Jacobian. The multibody system builds the Jacobian of the motion forces, and combine it with the Jacobian of the external forces.

Partitioning the Force Field into Effects

There are many forces that may be acting on the molecule, and these forces may be computed in various intrinsic coordinate frames that are most convenient for that particular force “effect”. For example, electrostatic terms may be computed using multipole methods and spherical coordinates, covalent terms may be computed in terms of torsion and bond angles, and solvent forces may be computed in global Cartesian coordinates. During the computation of the Residuals, these forces are transformed from their intrinsic coordinate frame to the MBS coordinates.

The same exchange occurs to compute Jacobians. The native Jacobians in their intrinsic coordinates are be brought into the MBS coordinates. This requires the use of the chain-rule to transform between intrinsic and the MBS generalized coordinates. It is important that each effect co-computes its function value and Jacobian, because many of the same terms are needed for each computation. Each effect is transformed into a set of spatial loads T_{effect}(k), where k is the index of a generic body in the system. The totality of these effects is given the symbol T(k).

Effect Jacobians Brought into the Residual Jacobian

At a high level, the residual routine was previously implemented from the equation

ρᵤ=Hφ(MA−T)

The implementation uses Order(N) methods which are immediately obvious from the equation above. In this equation T is a vector of spatial loads acting on the pivots of the multibody system, where each element is a spatial load (a 6-vector composed of one force and one torque). It actually represents all effects other than inertia loads or pure hinge loads. The term in parentheses represents the load balance for each body. The first term is the inertia force, the next is the spatial load. M(k)A(k) is the spatial inertia force for a typical body. This is built from the body mass properties and the spatial acceleration of the body pivot. The spatial acceleration is computed before the residual routine is executed by the Forward dynamics routine. The operator Hφ is implemented in a routine that performs an Order(N) inward pass.

Even without knowing anything about the details of the computation implied by the equation above, the contribution of

$$\frac{\partial T}{\partial x} ,$$

the spatial load Jacobian (the effect Jacobian) to

$$\frac{\partial {ρ}_{u}}{\partial x} ,$$

the residual Jacobian, can be immediately inferred:

$$\frac{\partial {ρ}_{u}}{\partial x} = - H φ \frac{\partial T}{\partial x} + …$$

The . . . refers to terms not involving the effect Jacobian. Again, q or u for “x”, is substituted, depending upon which partition of the Jacobian is being computed.

The role of an effect Jacobian in the residual Jacobian is the same as the role of the effect in the multibody equations. This means that T contributes to the residual ρᵤ in the same way that a column of

$$\frac{\partial T}{\partial x}$$

contributes to

$$\frac{\partial {ρ}_{u}}{\partial x} .$$

Both are processed by the same operator Hφ. This is a crucial point because it means that no new method is needed for this part of the Jacobian computation. (A different method is need to obtain

$$( A different method is need to obtain \frac{\partial T}{\partial x} ) .$$

Thus, given the effect Jacobian, its contribution is assembled into the residual Jacobian by operating on it with the original residual routine, treating it as a multi-column set of spatial load vectors. This is a direct consequence of the linearity of the equations.

The columns of the residual Jacobian play the same role in the derivative Jacobian routine as the residual vectors play in the Forward Dynamics routine. The dynamics routine performs a back-solve on a data vector it receives, and doesn't need to know what the data is, just what operation to perform on it. This applies to all the routines.

Adding the . . . terms, the chain rule is used to show the whole equation:

$$\frac{\partial {ρ}_{u}}{\partial x} = Hφ ( \frac{\partial ( MA )}{\partial x} - \frac{\partial T}{\partial x} ) + H \frac{\partial ( φ z )}{\partial x} + \frac{\partial ( Hy )}{\partial x}$$

At this level, there are four contributions to the Jacobian: the inertia forces, the spatial forces, and contributions due to changes in the operators φ and H. The quantities z and y refer to (MA−T), and φz, respectively, which are held fixed while evaluating the last two terms. The numerical values of these terms are already available from the residual computation. Another observation about the above equation is that the operator φ depends only upon q, but not u. Thus, this term remains constant while computing the partition Jᵤᵤ. Similarly, the spatial load can be split into its constituent effects, some of which do not depend upon u. In general, this means that knowledge of the multibody equations can be exploited to optimize the computations.

Up to now, what to do with

$$\frac{\partial T}{\partial x}$$

once the term has been computed has been described, but a description of how to form the term has not been made. These details are in the following sections.

Computing the Effect Jacobians and Combining with the Residual Jacobian

So far a high-level description of the Jacobian computation has been given. It can be seen that the computation has a very algorithmic flavor to it. There are very distinct phases to the task, just as there were also for the Forward Dynamics routine described previously. There, computation of atomic forces is clearly the bottleneck step. Yet the overhead in the multibody equations for dealing with forces is fairly small. In that case, a call was made to the force routine, and what occurs inside the routine was ignored. When it comes to the Jacobian, this aspect is less true.

A call is still made to obtain the Effect Jacobian, but there is a lot of processing needed before the Effect Jacobian can be assembled into the Residual Jacobian. The details of dealing with force fields to produce Jacobians are covered in the next sections and an example of incorporating electrostatics is developed. All other loads follow a similar development.

Electrostatics as an Example Effect

The basic premise of electrostatics is that the force between two charged particles is

$${F}_{ij} = κ \frac{{q}_{i} {q}_{j}}{{r}_{ij}^{2}} {\hat{r}}_{ij}$$

This is a classical inverse square law. Fᵢⱼ, the force acting on particle i due to particle j, depends upon the charge of the particles, attractive for oppositely charged particles, repulsive for like charges. The symbol \hat{r}ᵢⱼ is a unit vector directed from particle i to particles j; rᵢⱼ is the distance between the particles; k is a unit-dependent constant related to the strength of the forces. Of course, the force acting on particle j is equal and opposite to that acting on the particle i. Hence, given a collection of particles interacting through Coulomb's Law given above, the net force acting on each particle is computed by summing the pair-wise forces. For this example, the forces are computed in global Cartesian coordinates.

With the atomic forces in hand, the multibody forces can be generated. The system of forces acting on the particles of each body is replaced by a spatial load acting at the pivot of each body. The atomic forces are first expressed in a body-fixed basis, and then shifted to the pivot using the station coordinates of the particular atom to which the force is bound.

Fᵢⱼ is a vector. The derivative of Fᵢⱼ with respect to drᵢⱼ, small changes in the particle's relative positions is Dᵢⱼ, a tensor. It is such that dFᵢⱼ=Dᵢⱼ·drᵢⱼ. For Coulomb force the tensor is

$${{D}_{\underline{\_}}}_{ij} = κ \frac{1}{{r}_{ij}^{3}} ( {{E}_{\underline{\_}}}_{3} - 3 {\hat{r}}_{ij} {\hat{r}}_{ij}^{*} )$$

Some observations:

1. The Force Jacobian is a matrix of size nₐₜₒₘₛ×nₐₜₒₘₛ. Each element is a 3 by 3 tensor. The (i,j) block gives the derivative of force on atom i with respect to small changes in the position of atom j. In general, every force model is required to support an intrinsic Jacobian method for analytical processing.

2. Storage requirements for the Force Jacobian quickly become impractical. This leads to the notion of interface “contraction” where the Jacobian of all the forces acting pair-wise between the atoms are reduced or “contracted” to acting pair-wise between the bodies.

3. Because the Coulomb force is a pair-wise interaction, each force contributes to two blocks in the overall Jacobian. Thus, each force is processed at constant cost, and the overall Jacobian is computed at a cost proportional to the number of atoms squared, i.e., Order(N²) This is the same as the computational cost of the force itself! This is a rather good result for computing analytic Jacobians. A numerical Jacobian requires a fresh force computation each time an element of the state is perturbed. This leads to cubic growth, i.e., Order(N³), in the cost of the numerical Jacobian. Hence, the analytic Jacobian is much cheaper to compute as well as more accurate than a numerical Jacobian.

4. The computation of the Jacobian is conveniently done in the same routine that computes the force (co-computation). However, it typically needs to be done far less often than the force computation. Therefore, a flag can be used to trigger the Jacobian calculation only when needed.

Coupling to the Displacement Gradient

Having obtained the (intrinsic) Force Jacobian, it is necessary to process the Jacobian further. This is due to the fact that the multibody system is formulated using relative coordinates. The chain rule is applied to each atomic force F(k,i) and is called “coupling to the displacement gradient”. This denotes the global Cartesian force on atom i, which resides on body k.

$$\frac{\partial F ( k , i )}{\partial {q}_{j}} = {\sum }_{p = 1}^{nbod} {\sum }_{s ∈ p} \frac{\partial F ( k , i )}{\partial r ( p , s )} \frac{\partial r ( p , s )}{\partial {q}_{j}}$$

where r(p,s) is the position of atom “s” on body “p”.

The first term in the sum selects an element of the Force Jacobian which was just computed. The quantity

$$\frac{\partial r ( p , s )}{\partial {q}_{j}}$$

is an element of the displacement gradient. A typical term gives the change in an atom's position due to a small change in a generalized coordinate. Note that this term is strictly a kinematical quantity having nothing to do with the force computation. Thus, the Force Jacobian can be computed once and then continually reprocessed by the chain rule for each coordinate in the multibody system. This step represents a matrix vector multiply, since

$$\frac{\partial {r}_{j}}{\partial {q}_{s}}$$

is a column vector with nₐₜₒₘₛ entries (each a 3 vector), and the Jacobian is a square matrix nₐₜₒₘₛ×nₐₜₒₘₛ, where each element is a 3 by 3 tensor.

It is possible to improve this computation, since many of the entries in the displacement Jacobian are known to be zero. This is due to the fact that incrementing a particular hinge does not displace every atom in the system, but only those outboard of the displaced hinge, and not disjoint from the hinge in question. For instance, rotating the base body induces a change in all atoms of the system. But perturbing a torsion angle on any terminal body induces a change only to those atoms resident in the terminal body. Therefore, roughly speaking, about half the work may be saved by optimizing the computation. This reduction comes from a strictly knowledge-based approach.

Interface Contraction

In the process of forming T(k), the spatial load on body k, the load comes from the atomic forces acting on atoms that belong to body k. Each force is transformed from global to local coordinates, and then shifted to the body pivot. A concise statement of this procedure is:

$$T ( k ) = {\sum }_{i ∈ k} φ ( k , i ) T ( k , i )$$

The operator φ(k,i) is

$$φ ( k , i ) = {[ \begin{matrix}{{E}_{\underline{\_}}}_{3} & \tilde{ρ} ( k , i ) \\ {{0}_{\underline{\_}}}_{3} & {{E}_{\underline{\_}}}_{3}\end{matrix} ] [ \begin{matrix}{}_{}^{N}{C}{}_{}^{k} ( k ) & {{0}_{\underline{\_}}}_{3} \\ {{0}_{\underline{\_}}}_{3} & {}_{}^{N}{C}{}_{}^{k} ( k )\end{matrix} ]}^{*}$$

where ρ(k,i) are the fixed station coordinates of atom i on body k. Note that the new quantity T(k,i) appears. This is just the atomic force turned into a spatial load at the atomic position of atom i:

$$T ( k , i ) = [ \begin{matrix}{{0}_{\underline{\_}}}_{3} \\ F ( k , i )\end{matrix} ]$$

The first element of the atomic spatial load is zero because there is no torque exerted by the force field on individual atoms.

Now, T(k) relates atomic forces to body spatial loads. So, the derivative of this equation relates differential atomic forces to differential spatial loads:

$$\begin{matrix}\frac{\partial T ( k )}{\partial {q}_{j}} = {\sum }_{i ∈ k} φ ( k , i ) \frac{\partial T ( k , i )}{\partial {q}_{j}} + \frac{\partial φ ( k , i )}{\partial {q}_{j}} T ( k ) \\ = {T}_{1} ( k ) + {T}_{2} ( k )\end{matrix}$$

The second term, T₂(k), in this equation is discussed at the end of this section, as it involves the spatial loads, but not the load derivatives. This means the term can be treated generically, without worrying how the spatial loads were computed.

Substituting the definition of T(k), into T₁(k):

$$\begin{matrix}{T}_{1} ( k ) = {\sum }_{iε k}^{} φ ( k , i ) {\sum }_{p = 1}^{nbod} {\sum }_{sε p} \\ = {\sum }_{p = 1}^{nbod} {\sum }_{sε p} \frac{\partial T ( k )}{\partial r ( p , s )} \frac{\partial r ( p , s )}{\partial {q}_{j}}\end{matrix} \frac{\partial T ( k , i )}{\partial r ( p , s )} \frac{\partial r ( p , s )}{\partial {q}_{j}}$$

where now the symbol

$$\frac{\partial T ( k )}{\partial r ( p , s )} {=}^{Δ} {\sum }_{iε k} φ ( k , i ) \frac{\partial T ( k , i )}{\partial r ( p , s )}$$

is an element of the row-reduced Force Jacobian. This Jacobian relates differential (body) spatial loads directly to differential atomic displacements. Again, r(p,s) refers to the global position of the atom s on the body ρ. The term

$$\frac{\partial T ( k )}{\partial r ( p , s )}$$

is formed by summing each atomic Force Jacobian element into the destination element in the reduced Jacobian, weighted by the atoms' φ(k,i) matrix. Each element of the row-reduced Jacobian is a 6 by 3 matrix. Hence the rows of the Force Jacobian have been contracted. The contraction is evident in the notation: the numerator has only a body index, while the denominator has both a body and an atom index. Depending on the number of atoms per body, the row reduction can provide a savings in both storage and execution time when differential spatial loads must be formed.

Note that the row-reduction procedure only needs to be done once before computing the Residual Jacobian. The overhead of performing the reduction is more than offset by the reduced cost of the smaller matrix vector products which must be formed. Note that in forming

$$\frac{\partial T ( k )}{\partial r ( p , s )}$$

there is no need to save the elements of the atomic Force Jacobian. That is, each element

$$\frac{\partial T ( k , i )}{\partial r ( p , s )}$$

only needs to be available while its contribution to

$$\frac{\partial T ( k )}{\partial r ( p , s )}$$

is being computed. So, more than one element of the big Force Jacobian is not required at a time.

The global coordinates of a typical atom, r(p,s), are computed in terms of r(p), the global coordinates of body p's pivot, and ρ(p,s), the station coordinates of the atom:

r(p,s)=r(p)+^{N}C^{k}(p)ρ(p,s)

By differentiating we find, (with some results from the kinematics of finite rotations):

$$\frac{\partial r ( p , s )}{\partial {q}_{j}} = \frac{\partial r ( p )}{\partial {q}_{j}} - ( {}_{}^{N}{C}{}_{}^{k} ( p ) \tilde{ρ} ( p , s ) ) λ ( p )$$

Augmenting this equation with the additional equation λ(p,s)=λ(p) and defining w, the spatial derivative

the result is:

$$w {=}^{Δ} [ \begin{matrix}λ \\ \frac{\partial r}{\partial q}\end{matrix} ]$$

$$w ( p , s ) = [ \begin{matrix}λ ( p , s ) \\ \frac{\partial r ( p , s )}{\partial {q}_{j}}\end{matrix} ] = {φ ( p , s )}^{*} [ \begin{matrix}λ ( p ) \\ \frac{\partial r ( p )}{\partial {q}_{j}}\end{matrix} ]$$

The vector λ can be interpreted as generating a rate of change of orientation for each body. It is a field quantity, in the sense that it can potentially vary at each point in space. For rigid bodies undergoing pure rotations (without deformation), it is constant The second term, T₂(k), is given by:

$${T}_{2} ( k ) = {\sum }_{iε k} \frac{\partial φ ( k , i )}{\partial {q}_{j}} T ( k , i )$$

and involves the original spatial loads T(k) and derivative of the operator φ(k,i):

Thus

$$φ ( k , i ) = {[ \begin{matrix}{{E}_{\underline{\_}}}_{3} & \tilde{ρ} ( k , i ) \\ {{0}_{\underline{\_}}}_{3} & {{E}_{\underline{\_}}}_{3}\end{matrix} ] [ \begin{matrix}{}_{}^{N}{C}{}_{}^{k} ( k ) & {{0}_{\underline{\_}}}_{3} \\ {{0}_{\underline{\_}}}_{3} & {}_{}^{N}{C}{}_{}^{k} ( k )\end{matrix} ]}^{*}$$

$${T}_{2} ( k ) = {\sum }_{iε k} {[ \begin{matrix}{}_{}^{N}{dC}{}_{}^{k} ( k ) & \tilde{ρ} ( k , i ) {}_{}^{N}{dC}{}_{}^{k} ( k ) \\ {{0}_{\underline{\_}}}_{3} & {}_{}^{N}{dC}{}_{}^{k} ( k )\end{matrix} ]}^{*} T ( k , i ) \\$$

where

^{N}dC^{k}(k)=^{N}dC^{k}(i)ⁱC^{k}(k)+^{N}C^{k}(i)ⁱdC^{k}(k)

is computed recursively from the base body outward and

$${}_{}^{i}{dC}{}_{}^{k} ( k ) = \frac{{\partial }^{i} {C}^{k}}{\partial q ( k )} dq ( k ) k = 1 , … n$$

where dq(k) is defined in the next section, and

$$\frac{{\partial }^{i} {C}^{k} ( k )}{\partial {q}_{k}} ,$$

the partial derivative of the interbody direction cosine matrix is a function of the joint type connecting the bodies:

$$\text{pin:} \frac{{\partial }^{i} {C}^{k} ( k )}{\partial {q}_{k}} = - {\underline{\underline{E}}}_{3} sin ( {q}_{k} ) + \tilde{λ} cos ( {q}_{k} ) + {λλ}^{*} sin ( {q}_{k} )$$

$$\text{slider:} \frac{{\partial }^{i} {C}^{k} ( k )}{\partial {q}_{k}} = {\underline{\underline{0}}}_{3}$$

$$\text{ball and free:} \frac{{\partial }^{i} {C}^{k} ( k )}{\partial {ϵ}_{1}} = 2 [ \begin{matrix}0 & {ϵ}_{2} & {ϵ}_{3} \\ {ϵ}_{2} & - 2 {ϵ}_{1} & - {ϵ}_{4} \\ {ϵ}_{3} & {ϵ}_{4} & - 2 {ϵ}_{1}\end{matrix} ]$$

$$\frac{{\partial }^{i} {C}^{k} ( k )}{\partial {ϵ}_{2}} = 2 [ \begin{matrix}- 2 {ϵ}_{2} & {ϵ}_{1} & {ϵ}_{4} \\ {ϵ}_{1} & 0 & {ϵ}_{3} \\ - {ϵ}_{4} & {ϵ}_{3} & - 2 {ϵ}_{2}\end{matrix} ]$$

$$\frac{{\partial }^{i} {C}^{k} ( k )}{\partial {ϵ}_{3}} = 2 [ \begin{matrix}- 2 {ϵ}_{3} & - {ϵ}_{4} & {ϵ}_{1} \\ {ϵ}_{4} & - 2 {ϵ}_{3} & {ϵ}_{2} \\ {ϵ}_{1} & {ϵ}_{2} & 0\end{matrix} ]$$

$$\frac{{\partial }^{i} {C}^{k} ( k )}{\partial {ϵ}_{4}} = 2 [ \begin{matrix}0 & - {ϵ}_{3} & {ϵ}_{2} \\ {ϵ}_{3} & 0 & - {ϵ}_{1} \\ - {ϵ}_{2} & {ϵ}_{1} & 0\end{matrix} ]$$

In the next Section the Force Jacobians are combined with the Inertia Force Jacobians to finally form the Jacobian of the Residual Routine.

The Residual Jacobian

The previous Section describes the formation of the Force Jacobian

$$\frac{\partial T ( k )}{\partial w ( p )} ,$$

which must be coupled to the spatial displacement gradient, in order to form the derivative of the spatial forces. This section describes the formation of the spatial displacement gradient and the formation of the Jacobian of the residual routine.

The recursive algorithms for computing the entire Jacobian are described. The Jacobian algorithm is not actually set up to compute the Jacobian. As is typical of automatic differentiation routines, it computes the matrix vector product J_{uq}dq+Jᵤᵤdu for arbitrary passed-in values of the vectors dq and du. In practice, to compute the Jacobian, the “Jacobian Routine” is effectively called repeatedly with a series of Boolean vectors (a vector with one entry set to 1 and all other entries set to zero.) Each call generates the corresponding column of the Jacobian. Note that some of the steps have already been or are being computed for the Residual Form method or the Direct Form method (the Forward Dynamics Calculations), but are reproduced here for clarity.

1. Given (q,u) compute z [symbol] −M⁻¹ρᵤ(q,u,0) using the Direct Form method. Also set \dot{u}=z and recompute A(k), then ρᵤ, which recomputes \hat{T}(k).

2. Perform contraction to compute the fully row- and column-reduced Force Jacobian,

$$\frac{\partial T ( k )}{\partial w ( p )}$$

as described in section, “Interface Contraction”:

$$\frac{\partial T}{\partial w} = Φ \frac{\partial T}{\partial r} {Φ}^{*}$$

Steps 3 through 10 below are used to fill the columns of J_{uq}:

3. Compute the analytic Jacobian partitions of the \dot{q} terms:

$${J}_{qq} = \frac{\partial W ( q )}{\partial q} u$$

$${J}_{qu} = W$$

using joint routines similar to those needed for the First Kinematics Calculations.

4. Compute q derivatives of position quantities and terms for spatial gradient:

Previously described methods were used to fill in certain joint-specific fields. These quantities consisted of ⁱC^{k}(k), the interbody direction cosine matrices, r^{Q}^{ᵢ}^{Q}^{ₖ}(k), the spanning vector for each body, and H(k), the joint map for each body's inboard joint. To refer to the derivative of each of these quantities, a prefix ‘d’ is added to the symbol name to make this reference generically. Thus, ⁱdC^{k}(k) means the derivative of the direction cosine matrix ⁱC^{k}(k).

Each interbody direction cosine matrix (and all the joint-specific) quantities depend only on the generalized coordinates of an individual joint. Thus, ⁱdC^{k}(k) is nonzero only when the derivative is taken with respect to any of the coordinates for body k. To properly ‘seed’ the recursions being studying, a vector dq is passed in to the routine. For Jacobian computation we set one entry is set to 1, and all the other entries to 0. Then, the needed preliminary quantities are generated by a typical loop:

$${}_{}^{i}{dC}{}_{}^{k} ( k ) = \frac{{\partial }^{i} {C}^{k}}{\partial q ( k )} dq ( k ) k = 1 , … n$$

The partial derivatives of the direction cosine matrices are generated analytically and displayed in the section, “Interface Contraction” above. These partial derivatives do not depend upon the particular column of the Jacobian that is being computed. Setting a particular entry of dq to 1, and all the rest to 0 has the effect of annihilating the correct subset of the seed quantities.

$$\frac{\partial {r}^{{Q}_{i} {Q}_{k}} ( k )}{\partial {q}_{k}} ,$$

the partial derivative of the interbody spanning vector is given by

$$\frac{\partial {r}^{{Q}_{i} {Q}_{k}} ( k )}{\partial {q}_{k}} = λ ( k ) , \text{slider}$$

$$\frac{\partial {r}^{{Q}_{i} {Q}_{k}} ( k )}{\partial {q}_{k}} = {\underline{\underline{0}}}_{3 x4} , \text{ball}$$

$$\frac{\partial {r}^{{Q}_{i} {Q}_{k}} ( k )}{\partial {q}_{k}} = {\underline{0}}_{3} , \text{pin}$$

$$\frac{\partial {r}^{{Q}_{i} {Q}_{k}} ( k )}{\partial {q}_{k}} = [ \begin{matrix}0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ] , \text{free}$$

λ(k) here refers to the body's sliding axis which connects it to its parent body.

$$\frac{\partial H ( k )}{\partial {q}_{k}} ,$$

the partial derivative of the joint map is

$$\frac{\partial H ( k )}{\partial {q}_{k}} = {\underline{0}}_{6}^{*} , pin , slider$$

$$\frac{\partial H ( k )}{\partial {q}_{k}} = [ \begin{matrix}{{0}_{\underline{\_}}}_{3} & {{0}_{\underline{\_}}}_{3}\end{matrix} ] , ball$$

$$\frac{\partial H ( k )}{\partial {q}_{k}} = [ \begin{matrix}{{0}_{\underline{\_}}}_{3} & {{0}_{\underline{\_}}}_{3} \\ {{0}_{\underline{\_}}}_{3} & \frac{{\partial }^{i} {C}_{}^{k} ( k )}{\partial {q}_{k}}\end{matrix} ] , free$$

With the above definitions of the partial derivatives, the recursions are seeded with the following loop:

$$for k = 1 to nbod$$

$${}_{}^{i}{dC}{}_{}^{k} ( k ) = \frac{{\partial }^{i} {C}_{}^{k} ( k )}{\partial {q}_{k}} dq ( k )$$

$${dr}^{{Q}_{i} {Q}_{k}} ( k ) = \frac{\partial {r}^{{Q}_{i} {Q}_{k}} ( k )}{\partial {q}_{k}} dq ( k )$$

$$dH ( k ) = \frac{\partial H ( k )}{\partial {q}_{k}} dq ( k )$$

$$end \\$$

After execution of these loops, all bodies have ⁱdC^{k}(k), dr^{Q}^{ᵢ}^{Q}^{ₖ}(k), and dH(k), their interbody derivative quantities available.

One new quantity needed in the spatial displacement gradient computation is also computed. This is λ(k) from the section on Interface Contraction, the rotation axis that generates the rate of change of orientation for each body outboard of a perturbed joint. Here, this variable is given the symbol dθ(k), the differential rotation axis for each body is

for k=1 to nbod

dθ(k)=λ(k) dq(k), pin

dθ(k)=0₃, slider

dθ(k)=not needed for ball, free

end

Since arbitrary perturbations to a set of Euler parameters do not produce a pure rotation, column contraction cannot be used when computing the corresponding column of the Jacobian. The row-reduced Force Jacobian can still (and must) be used.

After seeding the recursions, ^{N}dC^{k}(k), dr^{OQ}^{ₖ}(k), ⁱdφ^{k}(k), dλ(k) are computed:

$${}_{}^{N}{dC}{}_{}^{k} ( 1 ) = {}_{}^{i}{dC}{}_{}^{k} ( 1 )$$

$${dr}^{{OQ}_{k}} ( 1 ) = {dr}^{{Q}_{i} {Q}_{k}} ( 1 )$$

$${}_{}^{i}{dφ}{}_{}^{k} ( 1 ) = {{0}_{\underline{\_}}}_{6}$$

$$dλ ( 1 ) = dθ ( 1 )$$

$$for k = 2 to nbod$$

$${}_{}^{N}{dC}{}_{}^{k} ( k ) = {}_{}^{N}{dC}{}_{}^{k} ( i ) {}_{}^{i}{C}{}_{}^{k} ( k ) + {}_{}^{N}{C}{}_{}^{k} ( i ) {}_{}^{i}{dC}{}_{}^{k} ( k )$$

$${dr}^{{OQ}_{k}} ( k ) = {dr}^{{OQ}_{k}} ( i ) + {}_{}^{N}{dC}{}_{}^{k} ( i ) {r}^{{Q}_{i} {Q}_{k}} ( k ) + {}_{}^{N}{C}{}_{}^{k} ( i ) {dr}^{{Q}_{i} {Q}_{k}} ( k )$$

$${}_{}^{i}{dφ}{}_{}^{k} ( k ) = [ \begin{matrix}a & b \\ c & d\end{matrix} ]$$

$$dλ ( k ) = {}_{}^{i}{C}{}_{}^{{k}^{*}} ( k ) dλ ( i ) + dθ ( k )$$

$$end$$

$$where$$

$$a = {}_{}^{i}{dC}{}_{}^{k} ( k ) , b = d {\tilde{r}}^{{Q}_{i} {Q}_{k}} ( k ) {}_{}^{i}{C}{}_{}^{k} ( k ) + {}_{}^{i}{dC}{}_{}^{k} ( k ) , \\ c = {{0}_{\underline{\_}}}_{3} , d = {}_{}^{i}{dC}{}_{}^{k} ( k )$$

5. Compute q derivatives of velocity:

A loop that computes the rate of change of joint velocity due to change in joint angle starts the process:

for k=1 to nbod

ⁱdν^{k}(k)=dH*(k)u(k)

end

This quantity is the rate of change of joint velocity due to change in joint angle. Obviously, it is nonzero only for joints whose map contains coordinate dependence. For free joints, the generalized speeds produce relative linear velocity that depends upon the joint orientation.

After computing ⁱdν^{k}(k), dV(k), the derivative of the spatial velocity of each body, is computed. This is done by the following loop:

dV(1)=ⁱdν^{k}(1)

for k=2 to nbod

dV(k)=ⁱdφ^{k}*V(i)+ⁱφ^{k*}dV(i)+ⁱdν^{k}(k)

end

6. Couple Force Jacobian to spatial displacement gradient to compute T₁(k)

$$for k = 1 to nbod$$

$${T}_{1} ( k ) = {\sum }_{p = 1}^{nbod} \frac{\partial T ( k )}{\partial w ( p )} \frac{\partial w ( p )}{\partial {q}_{j}}$$

end

7. Compute second term of the Force Jacobian T₂(k) and append to T₁(k):

for k=1 to nbod

$$dT ( k ) = {T}_{1} ( k ) + {\sum }_{iε k} {[ \begin{matrix}{}_{}^{N}{dC}{}_{}^{k} ( k ) & {\tilde{ρ} ( k , i )}^{N} {dC}^{k} ( k ) \\ {{0}_{\underline{\_}}}_{3} & {}_{}^{N}{dC}{}_{}^{k} ( k )\end{matrix} ]}^{*} T ( k , i )$$

end

8. Compute q derivatives of acceleration-related terms:

Again the process starts with a loop that computes ⁱda^{k}(k)=dH*(k)\dot{u}(k):

for k=1 to nbod

ⁱda^{k}(k)=dH*(k)\dot{u}(k)

end

This is the change in joint acceleration due to a change in coordinate. Then, dA(k), the derivative of the spatial acceleration of each body is computed.

$$dA ( 1 ) = {}_{}^{i}{da}{}_{}^{k} ( 1 )$$

$${}_{}^{i}{V}{}_{}^{k} ( k ) \to [ \begin{matrix}{}_{}^{i}{ω}{}_{}^{k} ( k ) \\ {}_{}^{i}{v}{}_{}^{{Q}_{k}} ( k )\end{matrix} ] , {}_{}^{i}{dV}{}_{}^{k} ( k ) \to [ \begin{matrix}{}_{}^{i}{dω}{}_{}^{k} ( k ) \\ {}_{}^{i}{dv}{}_{}^{{Q}_{k}} ( k )\end{matrix} ]$$

$$V ( k ) \to [ \begin{matrix}{}_{}^{N}{ω}{}_{}^{k} ( k ) \\ {}_{}^{N}{v}{}_{}^{{Q}_{k}} ( k )\end{matrix} ] , {dV}_{} ( k ) \to [ \begin{matrix}{}_{}^{N}{dω}{}_{}^{k} ( k ) \\ {}_{}^{N}{dv}{}_{}^{{Q}_{k}} ( k )\end{matrix} ]$$

where → means the 6 vector is decomposed into two 3 vectors, for k=2 to nbod

$$dt1 {=}^{Δ} {}_{}^{i}{dC}{}_{}^{{k}^{*}} ( k ) ( {}_{}^{N}{ω}{}_{}^{k} ( i ) \times ( {}_{}^{N}{ω}{}_{}^{k} ( i ) \times {r}^{{Q}_{i} {Q}_{k}} ( k ) ) ) + \\ {}_{}^{i}{C}{}_{}^{{k}^{*}} ( k ) ( \begin{matrix}( {}_{}^{N}{dω}{}_{}^{k} ( i ) \times ( {}_{}^{N}{ω}{}_{}^{k} ( i ) \times {r}^{{Q}_{i} {Q}_{k}} ( k ) ) ) + \\ ( {}_{}^{N}{ω}{}_{}^{k} ( i ) \times ( {}_{}^{N}{dω}{}_{}^{k} ( i ) \times {r}^{{Q}_{i} {Q}_{k}} ( k ) ) ) + \\ ( {}_{}^{N}{ω}{}_{}^{k} ( i ) \times ( {}_{}^{N}{ω}{}_{}^{k} ( i ) \times {dr}^{{Q}_{i} {Q}_{k}} ( k ) ) )\end{matrix} )$$

$$da {=}^{Δ} {}_{}^{i}{dφ}{}_{}^{{k}^{*}} ( k ) A ( i ) + {}_{}^{i}{φ}{}_{}^{{k}^{*}} ( k ) dA ( i ) + [ \begin{matrix}{{0}_{\underline{\_}}}_{3} \\ dt1\end{matrix} ]$$

$$ω j {=}^{Δ} {}_{}^{i}{C}{}_{}^{{k}^{*}} ( k ) {}_{}^{N}{ω}{}_{}^{k} ( i )$$

$$dω j {=}^{Δ} {}_{}^{i}{dC}{}_{}^{{k}^{*}} ( k ) {}_{}^{N}{ω}{}_{}^{k} ( i ) + {}_{}^{i}{C}{}_{}^{{k}^{*}} ( k ) {}_{}^{N}{dω}{}_{}^{k} ( i )$$

$$dt2 {=}^{Δ} dω j \times {}_{}^{i}{ω}{}_{}^{k} ( k ) + ω j \times {}_{}^{i}{dω}{}_{}^{k} ( k )$$

$$dt3 {=}^{Δ} 2 dω j \times {}_{}^{i}{v}{}_{}^{{Q}_{k}} ( k ) + 2 ω j \times {}_{}^{i}{dv}{}_{}^{{Q}_{k}} ( k )$$

$$dA ( k ) = da + [ \begin{matrix}dt2 \\ dt3\end{matrix} ] + {}_{}^{i}{da}{}_{}^{k} ( k )$$

$$end$$

The symbols introduced here with [symbol] are meant to be temporary variables not needed after computation of dA(k).

After computing the spatial acceleration derivatives, the computation of d\hat{T}(k), the spatial inertia force derivatives, is performed:

for k=1 to nbod

dν1 [symbol] ^{N}dω^{k}(k)×I_{Q}_{ₖ}(k)·^{N}ω^{k}+^{N}ω^{k}(k)×I_{Q}_{ₖ}(k)·^{N}dω^{k}

dν2 [symbol] ^{N}dω^{k}(k)×(^{N}ω^{k}(k)×p(k))+^{N}ω^{k}(k)×(^{N}dω^{k}(k)×p(k))

$$d \hat{T} ( k ) = M ( k ) dA ( k ) + [ \begin{matrix}dv1 \\ dv2\end{matrix} ] - dT ( k )$$

end

9. Compute dρ(k), the joint residual derivative for body k:

for k=nbod to 1

dρ(k)=dH(k)\hat{T}(k)+H(k)d\hat{T}(k)−dσ(k)

i=inb(k)

if i>0

d\hat{T}(i)=d\hat{T}(i)+ⁱdφ^{k}(k)\hat{T}(k)+ⁱφ^{k}(k)d\hat{T}(k)

end

end

After executing this routine, the values stored in dρ(k) are the new column of the Residual Jacobian

$$\frac{\partial }{\partial q} {ρ}_{u} ( q , u , z ) .$$

10. Back-solve the

$$\frac{\partial ρ}{\partial q}$$

result of previous step with the mass-matrix to obtain the desired

$$\frac{\partial \dot{u}}{\partial q} :$$

$$\frac{\partial \dot{u}}{\partial q} = - {M}^{- 1} \frac{\partial ρ}{\partial q}$$

The back-solve operation is accomplished in the Direct Form method routine by processing a residual vector into a \dot{u} vector. The Second Kinematics Calculations only needs to be performed once for the whole Jacobian, since the back-solves are done at the nominal value of the state. In fact, the Second Kinematics routine must have been called in Step 1 while computing z, so the variables should still be cached.

Steps 11 through 13 below are used to fill the columns of Jᵤᵤ:

11. Compute u derivatives of velocity:

This routine takes a passed-in vector du and computes ⁱdν^{k}(k)=H*(k)du(k). Then, dV(k), the derivative of the spatial velocity of each body, is computed:

dV(1)=ⁱdν^{k}(1)

for k=2 to nbod

dV(k)=ⁱφ^{k}*(k)dV(i)+ⁱdν^{k}(k)

end

12. Compute the velocity-induced derivative d\hat{T}(k). As presented here, the routine is specialized for the case of no velocity dependent external loads. The surviving terms are those due to changes in inertia forces alone. Even if there were changes in external loads, it would only be required to include the contribution of dT(k) as before.

$$dA ( 1 ) = [ \begin{matrix}{{0}_{\underline{\_}}}_{3} \\ {{0}_{\underline{\_}}}_{3}\end{matrix} ]$$

$$for k = 2 to nbod$$

$$dt1 {=}^{Δ} {}_{}^{i}{C}{}_{}^{{k}^{*}} ( k ) ( \begin{matrix}( {}_{}^{N}{dω}{}_{}^{k} ( i ) \times ( {}_{}^{N}{ω}{}_{}^{k} ( i ) \times {r}^{{Q}_{i} {Q}_{k}} ( k ) ) ) + \\ ( {}_{}^{N}{ω}{}_{}^{k} ( i ) \times ( {}_{}^{N}{dω}{}_{}^{k} ( i ) \times {r}^{{Q}_{i} {Q}_{k}} ( k ) ) )\end{matrix} )$$

$$da {=}^{Δ} {}_{}^{i}{φ}{}_{}^{{k}^{*}} ( k ) dA ( i ) + [ \begin{matrix}{\underline{0}}_{3} \\ dt1\end{matrix} ]$$

$$ω j {=}^{Δ} {}_{}^{i}{C}{}_{}^{{k}^{*}} ( k ) {}_{}^{N}{ω}{}_{}^{k} ( i )$$

$$dω j {=}^{Δ} {}_{}^{i}{C}{}_{}^{{k}^{*}} ( k ) {}_{}^{N}{dω}{}_{}^{k} ( i )$$

$$dt2 {=}^{Δ} dω j \times {}_{}^{i}{ω}{}_{}^{k} ( k ) + ω j \times {}_{}^{i}{dω}{}_{}^{k} ( k )$$

$$dt3 {=}^{Δ} 2 dω j \times {}_{}^{i}{v}{}_{}^{{Q}_{k}} ( k ) + 2 ω j \times {}_{}^{i}{dv}{}_{}^{{Q}_{k}} ( k )$$

$$dA ( k ) = da + [ \begin{matrix}dt2 \\ dt3\end{matrix} ]$$

After computing the spatial acceleration derivatives, d\hat{T}(k), the spatial inertia force derivatives, is computed:

$$for k = 1 to nbod$$

$$dv1 {=}^{Δ} {}^{N} d {ω}^{k} ( k ) \times {{I}_{\underline{\_}}}_{{Q}_{k}} ( k ) \cdot {}_{}^{N}{ω}{}_{}^{k} + {}_{}^{N}{ω}{}_{}^{k} ( k ) \times {{I}_{\underline{\_}}}_{{Q}_{k}} ( k ) \cdot {}^{N} d {ω}^{k}$$

$$dv2 {=}^{Δ} {}^{N} d {ω}^{k} ( k ) \times ( {}_{}^{N}{ω}{}_{}^{k} ( k ) \times p ( k ) ) + {}_{}^{N}{ω}{}_{}^{k} ( k ) \times ( {}^{N} d {ω}^{k} ( k ) \times p ( k ) )$$

$$d \hat{T} ( k ) = M ( k ) dA ( k ) + [ \begin{matrix}dv1 \\ dv2\end{matrix} ]$$

$$end$$

13. Compute dρ(k), the joint residual derivative for body k:

for k=nbod to 1

dρ(k)=H(k)d\hat{T}(k)−dσ(k)

i=inb(k)

if i>0

d\hat{T}(i)=d\hat{T}(i)+ⁱφ^{k}(k)d\hat{T}(k)

end

end

After executing this routine the values stored in dρ(k) are the new column of the Residual Jacobian

$$\frac{\partial }{\partial u} {ρ}_{u} ( q , u , z ) .$$

14. Back-solve the

$$\frac{\partial ρ}{\partial u}$$

result of previous step with the mass-matrix to obtain the desired

$$\frac{\partial \dot{u}}{\partial u} :$$

$$\frac{\partial \dot{u}}{\partial u} = - {M}^{- 1} \frac{\partial ρ}{\partial u}$$

The back-solve operation is accomplished in the Direct Method routine by processing a residual vector into a \dot{u} vector. The Second Kinematics Calculations only need to be performed once, since the back-solves are done at the nominal value of the state. In fact, the Second Kinematics routine must have been called in Step 1 while computing z, so the variables should still be cached.

The above steps complete the computation of the analytic Jacobian as long as the forces only have dependence on q. This accommodates the classical situation where all atomic forces are derivable from a potential function. To accommodate velocity-dependent forces, such as simple viscous damping, some of the above steps need to be modified as follows:

In Step 2 above, we also need to compute the contracted velocity Jacobian

$$\frac{\partial T ( k )}{\partial \dot{r} ( k )} ,$$

which is block diagonal, must also be computed.

In Step 6 above, the computation of T₁(k) must be augmented with the contracted velocity Jacobian:

for k=1 to nbod

$${T}_{1} ( k ) = {\sum }_{p = 1}^{nbod} \frac{\partial T ( k )}{\partial w ( p )} \frac{\partial w ( p )}{\partial {q}_{j}} + {\sum }_{iε k} \frac{\partial T ( k )}{\partial \dot{r} ( k , i )} \frac{\partial \dot{r} ( k , i )}{\partial {q}_{j}}$$

end

where

$$\frac{\partial \dot{r} ( k , i )}{\partial {q}_{j}} = {}_{}^{N}{dC}{}_{}^{k} ( k ) [ {}_{}^{N}{v}{}_{}^{{Q}_{k}} ( k ) + {}_{}^{N}{ω}{}_{}^{k} ( k ) \times ρ ( k , i ) ] + \\ {}_{}^{N}{C}{}_{}^{k} ( k ) [ {}_{}^{N}{dv}{}_{}^{{Q}_{k}} ( k ) + {}_{}^{N}{dω}{}_{}^{k} ( k ) \times ρ ( k , i ) ]$$

A step is then added after Step 11, which is called Step 11a. This new step computes dT(k):

where

$$dT ( k ) = {\sum }_{i ∈ k} \frac{\partial T ( k )}{\partial \dot{r} ( k , i )} \frac{\partial \dot{r} ( k , i )}{\partial {u}_{j}}$$

$$\text{where}$$

$$\frac{\partial \dot{r} ( k , i )}{\partial {u}_{j}} = {}_{}^{N}{C}{}_{}^{k} ( k ) [ {}_{}^{N}{dv}{}_{}^{{Q}_{k}} ( k ) + {}^{N} d {ω}^{k} ( k ) \times ρ ( k , i ) ]$$

While executing Step 12 above, the last loop for d\hat{T}(k) is modified by subtracting the velocity-dependent force derivative dT(k):

$$\text{for} k = 1 \text{to} nbod$$

$$dv1 {=}^{Δ} {}^{N} d {ω}^{k} ( k ) \times {\underline{\underline{I}}}_{{Q}_{k}} ( k ) \cdot {}_{}^{N}{ω}{}_{}^{k} + {}_{}^{N}{ω}{}_{}^{k} ( k ) \times {\underline{\underline{I}}}_{{Q}_{k}} ( k ) \cdot {}^{N} d {ω}^{k}$$

$$dv2 {=}^{Δ} {}^{N} d {ω}^{k} ( k ) \times ( {}_{}^{N}{ω}{}_{}^{k} ( k ) \times p ( k ) ) + {}_{}^{N}{ω}{}_{}^{k} ( k ) \times ( {}^{N} d {ω}^{k} ( k ) \times p ( k ) )$$

$$d \hat{T} ( k ) = M ( k ) dA ( k ) + [ \begin{matrix}dv1 \\ dv2\end{matrix} ] - dT ( k )$$

end

The rest of the Steps remain the same.

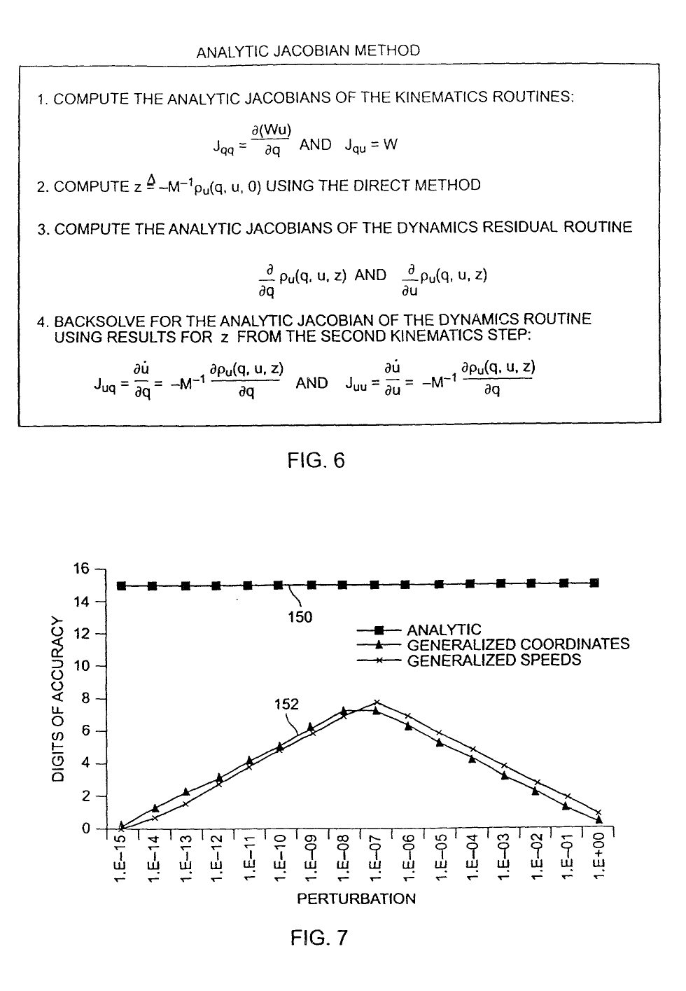

FIG. 6 summarizes the operational steps of the Analytic Jacobian method, which has been described in detail above.

FIG. 7 shows a plot of the accuracy of the numerical Jacobian versus the accuracy of the analytic Jacobian for an exemplary MD system. In the best case in which the perturbation was perfectly selected, the digits of accuracy for the generalized coordinates (q) and generalized speeds (u) from the numerical Jacobian, illustrated by line 152, were still only half that of the analytic Jacobian, illustrated by line 150.

Additional Embodiments

The present invention has many embodiments besides the examples described above. The list below has other embodiments and applications:

Order of Forces Included in Jacobian

Any order of the forces to be included in the Jacobian, include, but not limited to Order(N), Order(N²), Order(N³), and Order(N⁴). An example of an Order(N) force field would be an electrostatic force field using fast multi-pole expansion methods (see, for example, Greengaard, The Rapid Evaluation of Potential Fields in Particle Systems, Massachusetts Institute of Technology Dissertation, 1988) rather than direct method which is Order(N²).

Analytic Jacobian for Direct Form

When the governing equations are in Direct Form, the so-called “forward dynamics” form of the equations is obtained. In this form, the equations process a state vector and applied efforts and generate the acceleration at each of the joints modeled in the system.

\dot{u}=M⁻¹(ƒ)

The Jacobian then represents the partial derivatives of the accelerations with respect to elements of the state vector. The preferred embodiment shows several algorithmic methods for computation of these partial derivatives. The methods are exact and do not utilize numerical approximations to form derivatives.

The Direct Form produces the \dot{u} partitions of the Jacobian:

and

$${J}_{uq} = \frac{\partial ( {M}^{- 1} ( f ) )}{\partial q}$$

$$\text{and}$$

$${J}_{uu} = \frac{\partial ( {M}^{- 1} ( f ) )}{\partial u}$$

by using an algorithmic counterpart to the function which computes the \dot{u} function.

What is claimed is:

1. A method of modeling the behavior of a molecule, comprising
selecting a torsion angle, rigid multibody model for said molecule, said model having equations of motion;
selecting an implicit integrator; and
generating an analytic Jacobian for said implicit integrator to integrate said equations of motion so as to obtain calculations of said behavior of said molecule.

2. The method of claim 1 wherein said analytic Jacobian is derived from an analytic Jacobian of the Residual Form of the equations of motion.

3. The method of claim 2 wherein said analytic Jacobian J comprises
$$J = ( \begin{matrix}\frac{\partial \dot{q}}{\partial q} & \frac{\partial \dot{q}}{\partial u} \\ \frac{\partial \dot{u}}{\partial q} & \frac{\partial \dot{u}}{\partial u}\end{matrix} ) {=}^{Δ} ( \begin{matrix}{J}_{qq} & {J}_{qu} \\ {J}_{uq} & {J}_{uu}\end{matrix} ) ; \text{and}$$
$${J}_{qq} = \frac{\partial \dot{q}}{\partial q} = \frac{\partial ( W u )}{\partial q} \text{and} {J}_{qu} = \frac{\partial \dot{q}}{\partial u} = W$$
$${J}_{uq} = \frac{\partial \dot{u}}{\partial q} = - {M}^{- 1} \frac{\partial {ρ}_{u} ( q , u , z )}{\partial q} \text{and} {J}_{uu} = \frac{\partial \dot{u}}{\partial u} = - {M}^{- 1} \frac{\partial {ρ}_{u} ( q , u , z )}{\partial u}$$
where q are the generalized coordinates, u are the generalized speeds, W is a joint map matrix and M is the mass matrix and ρᵤ is the dynamic residual of the equations of motion, and z is −M⁻¹ρᵤ(q,u,0).

4. The method of claim 3 wherein said implicit integrator selecting step comprises an L-stable integrator.

5. A method of simulating the behavior of a physical system, comprising
modeling said physical system with a torsion angle, rigid multibody model, said model having equations of motion; and
integrating said equations of motion with an implicit integrator; said implicit integrator having an analytic Jacobian to obtain calculations of said behavior of said physical system.

6. The method of claim 5 wherein said analytic Jacobian is derived from an analytic Jacobian of the Residual Form of the equations of motion.

7. The method of claim 6 wherein said analytic Jacobian J comprises
$$J = ( \begin{matrix}\frac{\partial \dot{q}}{\partial q} & \frac{\partial \dot{q}}{\partial u} \\ \frac{\partial \dot{u}}{\partial q} & \frac{\partial \dot{u}}{\partial u}\end{matrix} ) {=}^{Δ} ( \begin{matrix}{J}_{qq} & {J}_{qu} \\ {J}_{uq} & {J}_{uu}\end{matrix} ) ; \text{and}$$
$${J}_{qq} = \frac{\partial \dot{q}}{\partial q} = \frac{\partial ( W u )}{\partial q} \text{and} {J}_{qu} = \frac{\partial \dot{q}}{\partial u} = W$$
$${J}_{uq} = \frac{\partial \dot{u}}{\partial q} = - {M}^{- 1} \frac{\partial {ρ}_{u} ( q , u , z )}{\partial q} \text{and} {J}_{uu} = \frac{\partial \dot{u}}{\partial u} = - {M}^{- 1} \frac{\partial {ρ}_{u} ( q , u , z )}{\partial u}$$
where q are the generalized coordinates, u are the generalized speed, W is a joint map matrix and M is the mass matrix and ρᵤ is the dynamic residual of the equations of motion, and z is −M⁻¹ρᵤ(q,u,0).

8. The method of claim 7 wherein said implicit integrator comprises an L-stable integrator.

9. Computer code for simulating the behavior of a molecule, said code comprising
a first module for a torsion angle, rigid multibody model of said molecule, said model having equations of motion; and
a second module for an implicit integrator to integrate said equations of motion with an analytic Jacobian to obtain calculations of said behavior of said molecule.

10. The computer code of claim 9 wherein said analytic Jacobian is derived from an analytic Jacobian of the Residual Form of the equations of motion.

11. The computer code of claim 10 wherein said analytic Jacobian J comprises
$$J = ( \begin{matrix}\frac{\partial \dot{q}}{\partial q} & \frac{\partial \dot{q}}{\partial u} \\ \frac{\partial \dot{u}}{\partial q} & \frac{\partial \dot{u}}{\partial u}\end{matrix} ) {=}^{Δ} ( \begin{matrix}{J}_{qq} & {J}_{qu} \\ {J}_{uq} & {J}_{uu}\end{matrix} ) ; \text{and}$$
$${J}_{qq} = \frac{\partial \dot{q}}{\partial q} = \frac{\partial ( W u )}{\partial q} \text{and} {J}_{qu} = \frac{\partial \dot{q}}{\partial u} = W$$
$${J}_{uq} = \frac{\partial \dot{u}}{\partial q} = - {M}^{- 1} \frac{\partial {ρ}_{u} ( q , u , z )}{\partial q} \text{and} {J}_{uu} = \frac{\partial \dot{u}}{\partial u} = - {M}^{- 1} \frac{\partial {ρ}_{u} ( q , u , z )}{\partial u}$$
where q are the generalized coordinates, u are the generalized speed, W is a joint map matrix and M is the mass matrix and ρᵤ is the dynamic residual of the equations of motion, and z is −M⁻¹ρᵤ(q,u,0).

12. The computer code of claim 11 wherein said implicit integrator comprises an L-stable integrator.

13. Computer code for simulating the behavior of a physical system, said code comprising
a first module for a torsion angle, rigid multibody model of said system, said model having equations of motion; and
a second module for an implicit integrator to integrate said equations of motion with an analytic Jacobian to obtain calculations of said behavior of said system.

14. The computer code of claim 13 wherein said analytic Jacobian is derived from an analytic Jacobian of the Residual Form of the equations of motion.

15. The computer code of claim 14 wherein said analytic Jacobian J comprises
$$J = ( \begin{matrix}\frac{\partial \dot{q}}{\partial q} & \frac{\partial \dot{q}}{\partial u} \\ \frac{\partial \dot{u}}{\partial q} & \frac{\partial \dot{u}}{\partial u}\end{matrix} ) {=}^{Δ} ( \begin{matrix}{J}_{qq} & {J}_{qu} \\ {J}_{uq} & {J}_{uu}\end{matrix} ) ; \text{and}$$
$${J}_{qq} = \frac{\partial \dot{q}}{\partial q} = \frac{\partial ( W u )}{\partial q} \text{and} {J}_{qu} = \frac{\partial \dot{q}}{\partial u} = W$$
$${J}_{uq} = \frac{\partial \dot{u}}{\partial q} = - {M}^{- 1} \frac{\partial {ρ}_{u} ( q , u , z )}{\partial q} \text{and} {J}_{uu} = \frac{\partial \dot{u}}{\partial u} = - {M}^{- 1} \frac{\partial {ρ}_{u} ( q , u , z )}{\partial u}$$
where q are the generalized coordinates, u are the generalized speed, W is a joint map matrix and M is the mass matrix and ρᵤ is the dynamic residual of the equations of motion, and z is −M⁻¹ρᵤ(q,u,0).

16. The computer code of claim 15 wherein said implicit integrator comprises an L-stable integrator.
